(19) United States
(12) Patent Application Publication
(10) Pub. No.: US 2023/0419716 A1
(43) Pub. Date: Dec. 28, 2023

(54) IMAGE PROCESSING METHOD, APPARATUS, AND DEVICE, STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Xingyao CHEN, Shenzhen (CN); Junda BEI, Shenzhen (CN)

(21) Appl. No.: 18/460,416

(22) Filed: Sep. 1, 2023

Related U.S. Application Data
(63) Continuation of application No. PCT/CN2022/119824, filed on Sep. 20, 2022.

(30) Foreign Application Priority Data
Nov. 15, 2021 (CN) 202111351245.5

(51) Int. Cl. G06V 30/418; G06V 30/18; G06V 30/19; G06F 40/166; G06F 40/30

(52) U.S. Cl. CPC G06V 30/418; G06V 30/18105; G06V 30/19093; G06F 40/166; G06F 40/30

(57) ABSTRACT

An image processing method includes displaying a document editing interface including a target document, and displaying a matching image that matches the target document in response to an image generation trigger event. An image appearance attribute of the matching image characterizes semantic information of the target document, and an image content attribute of the matching image characterizes document content in the target document.

### CROSS-REFERENCE TO RELATED APPLICATIONS

This application is a continuation of International Application No. PCT/CN2022/119824, filed on Sep. 20, 2022, which claims priority to Chinese Patent Application No. 2021113512455 filed with the China National Intellectual Property Administration on Nov. 15, 2021 and entitled “IMAGE PROCESSING METHOD, APPARATUS, AND DEVICE, STORAGE MEDIUM, AND COMPUTER PROGRAM PRODUCT,” which are incorporated herein by reference in their entirety.

### FIELD OF THE TECHNOLOGY

This application relates to the field of computer technologies, and in particular, to an image processing method, apparatus, and device, a storage medium, and a computer program product.

### BACKGROUND OF THE DISCLOSURE

With the development of Internet technologies, lives of people are becoming more and more convenient. Traditionally, when reading a document, a user may need to carefully or seriously read all characters or core characters of the document to acquire a theme or central content of the document. At present, in order to provide convenience for the user, an image that matches the document may usually be generated, so that the user may intuitively and quickly acquire theming content of the document through the image. For example, when filling a collection sheet or writing the document, the user often needs to add a header image (or referred to as a theming image) to the collection sheet, so that the user can see the theme of the collection sheet at a glance. When sharing, a cover graph that can highlight the theme quite well is also required to help other users see the central content of the collection sheet at a glance.

In a related technology, an image template is often determined according to the theme selected by the user in one image generation application, then the user performs an image design on the image template according to the document content, and finally, an image that matches the document is generated. If the user makes an image design independently, it requires the user to have certain graphic design foundation and takes a long time to obtain a beautiful image. It can be seen that an image generation method in the related technology has low efficiency and is complicated for users.

### SUMMARY

In accordance with the disclosure, there is provided an image processing method including displaying a document editing interface including a target document, and displaying a matching image that matches the target document in response to an image generation trigger event. An image appearance attribute of the matching image characterizes semantic information of the target document, and an image content attribute of the matching image characterizes document content in the target document.

Also in accordance with the disclosure, there is provided an image processing device including a processor and a computer-readable storage medium storing one or more computer-readable instructions that, when executed by the processor, cause the processor to display a document editing interface including a target document, and display a matching image that matches the target document in response to an image generation trigger event. An image appearance attribute of the matching image characterizes semantic information of the target document, and an image content attribute of the matching image characterizes document content in the target document.

Also in accordance with the disclosure, there is provided a non-transitory computer-readable storage medium, storing one or more computer-readable instructions that, when executed by a processor, cause the processor to display a document editing interface including a target document, and display a matching image that matches the target document in response to an image generation trigger event. An image appearance attribute of the matching image characterizes semantic information of the target document, and an image content attribute of the matching image characterizes document content in the target document.

### BRIEF DESCRIPTION OF THE DRAWINGS

In order to describe the technical solutions in the embodiments of this application more clearly, the drawings required to be used in descriptions about the embodiments will be simply introduced below. Apparently, the drawings in the following descriptions are some embodiments of this application. Those of ordinary skill in the art may further obtain other drawings according to these drawings without creative work.

FIG. 1 is a schematic structural diagram of an image processing system provided by an embodiment of this application.

FIG. 2 is a schematic flowchart of an image processing method provided by an embodiment of this application.

FIG. 3A is a schematic diagram showing one document editing interface provided by an embodiment of this application.

FIG. 3B is a schematic diagram showing another document editing interface provided by an embodiment of this application.

FIG. 3C is a schematic diagram showing displaying an invitation window provided by an embodiment of this application.

FIG. 3D is a schematic diagram showing an invitation window provided by an embodiment of this application.

FIG. 3E is a schematic diagram showing setting an operation permission of a collaborator provided by an embodiment of this application.

FIG. 4A is a schematic diagram showing inputting a sharing operation provided by an embodiment of this application.

FIG. 4B is a schematic diagram showing sharing a target document provided by an embodiment of this application.

FIG. 4C is a schematic diagram showing an inserting operation for inserting an image provided by an embodiment of this application.

FIG. 5A is one schematic diagram showing displaying a matching image provided by an embodiment of this application.

FIG. 5B is another schematic diagram showing displaying a matching image provided by an embodiment of this application.

FIG. 6 is a schematic flow chart of another image processing method provided by an embodiment of this application.

FIG. 7A is a schematic diagram showing playing a waiting animation provided by an embodiment of this application.

FIG. 7B is a schematic diagram showing sharing a matching image provided by an embodiment of this application.

FIG. 7C is a schematic diagram showing sharing a matching image provided by an embodiment of this application.

FIG. 8 is a schematic flowchart of another image processing method provided by an embodiment of this application.

FIG. 9A is a schematic diagram showing setting a specified theme for a target document provided by an embodiment of this application.

FIG. 9B is a schematic diagram showing disassembling a target document provided by an embodiment of this application.

FIG. 9C is a schematic diagram showing performing face recognition on content illustration provided by an embodiment of this application.

FIG. 10 is a schematic architectural diagram showing generating a matching image provided by an embodiment of this application.

FIG. 11 is a schematic structural diagram showing an image processing apparatus provided by an embodiment of this application.

FIG. 12 is a schematic structural diagram of an image processing device provided by an embodiment of this application.

### DESCRIPTION OF EMBODIMENTS

Technical solutions in embodiments of this application are clearly and completely described below with reference to the drawings in the embodiments of this application.

Embodiments of this application provide an image processing solution, which is mainly used for generating a matched matching image for a target document. The target document may be a plain character document, may be a collection sheet document, or may also be a document including a character and an illustration. The target document may be edited through a document editing interface. When there is an image generation trigger event, semantic analysis processing may be performed, in response to the image generation trigger event, on the target document to obtain semantic information of the target document. Further, a matching image appearance attribute is designed based on the semantic information of the target document, an image content attribute is designed based on the document content in the target document, and finally, typesetting processing is performed on the image appearance attribute and the image content attribute to obtain a matching image that matches the target document.

The image processing solution may be performed by an image processing device. One document application may run in the image processing device. The document application may be used for editing or reading a document. The target document is edited in the document editing interface of the document application. The image processing device may be a computer device, and specifically, may be a terminal device, for example, a smartphone, a tablet computer, a notebook computer, a desktop computer, a smart speaker, a smart watch, an on board terminal, a smart home appliance, a smart voice interaction device, or the like. Or, the image processing device may also be a server, for example, an independent physical server, or may also be a server cluster or a distributed system composed of a plurality of physical servers, or may also be a cloud server providing basic cloud computing services.

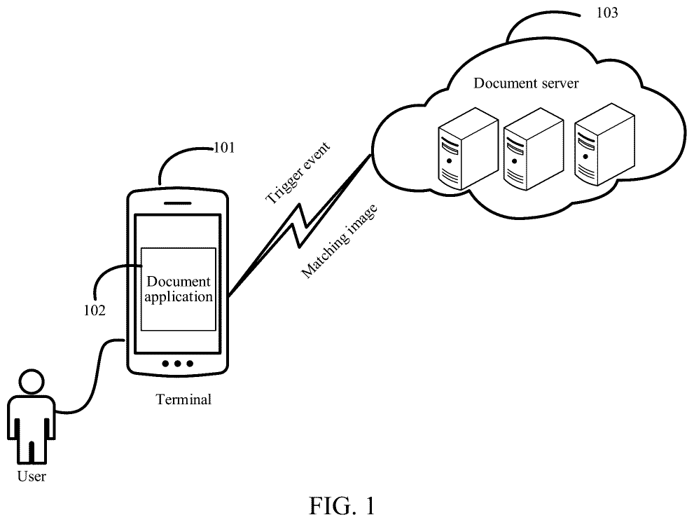

A matching image that matches the target document may be generated by the image processing device, or the matching image may also be generated by a document server corresponding to the document application. The document server provides support for the running of the document application in the image processing device. It is assumed that the matching image is generated by the document server, with reference to FIG. 1, which is a schematic structural diagram of an image processing system provided by an embodiment of this application. In FIG. 1, 101 represents an image processing device, 102 represents a document application running in the image processing device, and 103 represents a document server. The image processing device 101 displays a document editing interface in the document application, so that a user edicts a target document through the document editing interface.

When it is detected that there is an image generation trigger event, the image processing device 101 informs the document server 103 of the image generation trigger event. The document server 103 acquires a current target document in the document application 102, and then performs semantic analysis on the target document to obtain semantic information of the target document. Further, an image appearance attribute is determined based on image attribute reference information and semantic information, and an image content attribute is determined based on related information of document content in the target document, and finally, typesetting processing is performed on the image appearance attribute and the image content attribute to generate a matching image that matches the target document. The document server 103 returns the generated matching image to the image processing device 101, and the image processing device 101 displays the matching image.

The related information of the document content in the target document may include the document content and document layout. The document content includes text and an illustration. The document layout may have a chapter structure or a chapter-free structure. The image attribute reference information an association relationship between a plurality of image appearance attributes and semantic information.

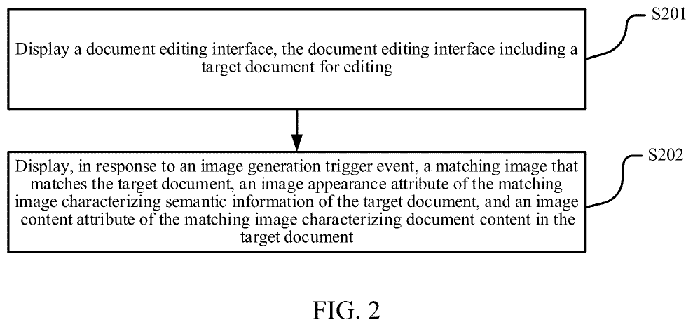

Based on the above image processing solution and image processing system, the embodiments of this application provide an image processing method, with reference to FIG. 2, which is a schematic flowchart of an image processing method provided by an embodiment of this application. The image processing method shown in FIG. 2 is performed by the image processing device, specifically, may be performed by a processor of the image processing device. The image processing method in FIG. 2 may include the following steps:
S201: Display a document editing interface. The document editing interface includes a target document for editing.

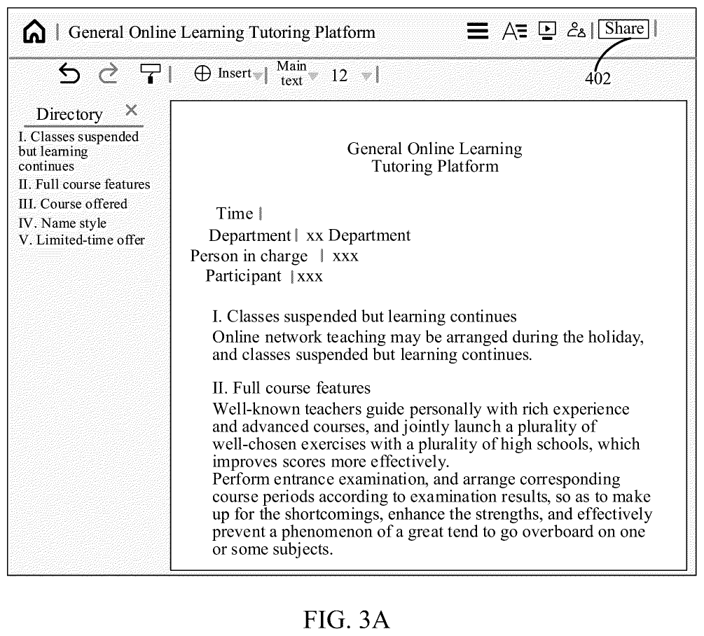

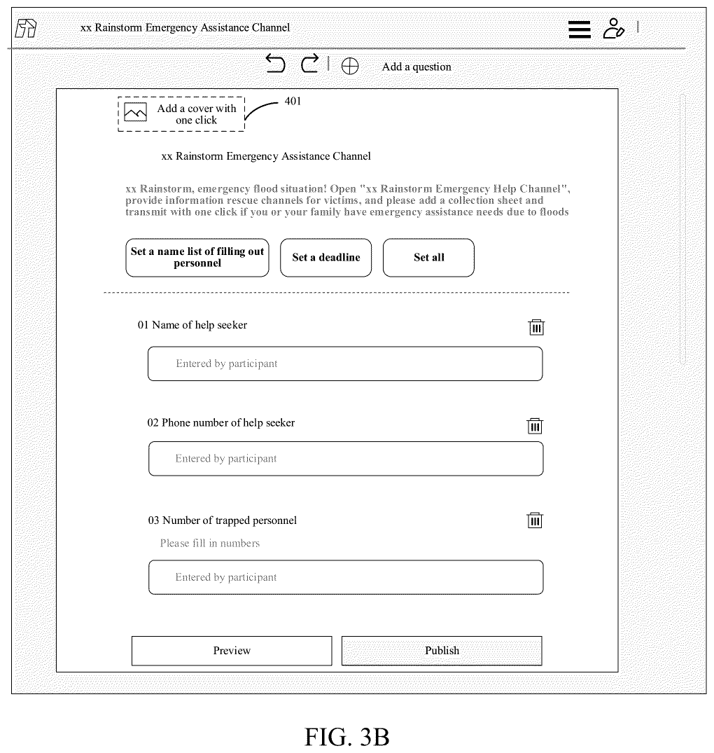

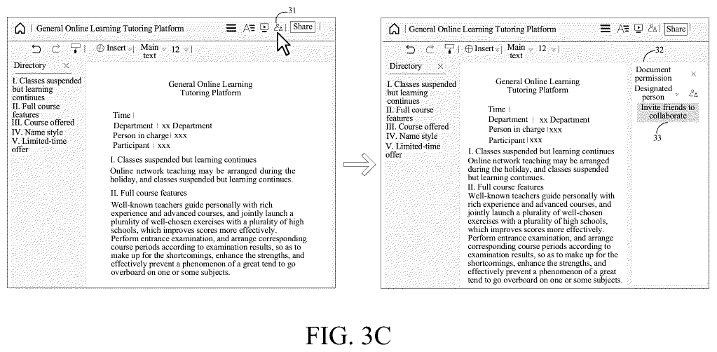

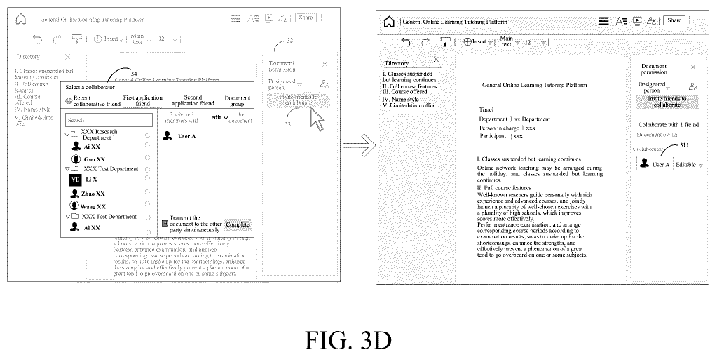

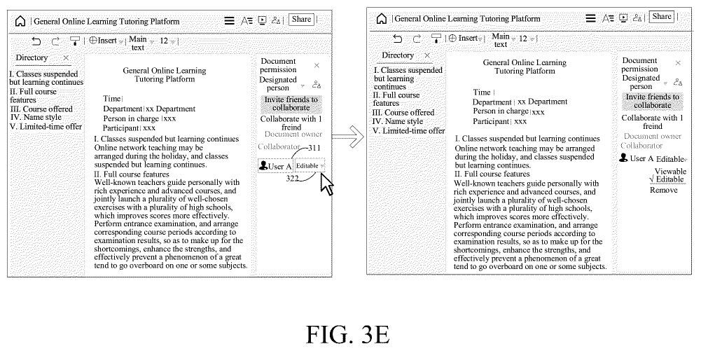

Optionally, the document editing interface may be an interface that is in the document application and is used for editing the target document. The target document may be a text document, as shown in FIG. 3A. The document editing interface displays a text document for editing, which is entitled “General Online Learning Tutoring Platform.” Or, the target document may also be a sheet document, for example, an xx information collection sheet, as shown in FIG. 3B. The document editing interface displays a sheet document for editing, and information collection may be performed through the sheet document.

Optionally, the target document may be a collaborative document. The so-called collaborative document refers to the target document that a collaborator selected by a creator may view or edit (viewing or editing may be considered as the operation permission of the collaborator on the target document). For example, in FIG. 3C, the document editing interface includes an invitation option 31. If the creator of the target document selects the invitation option 31, the document editing interface displays a collaboration window, indicated by 32 in FIG. 3C. The collaboration window 32 may include a collaborative user adding option 33. A selection window, indicated by 34 in FIG. 3D, is displayed by triggering the collaborative user adding option 33. A user that can read or edit the target document may be selected in 34. Assuming that user A is selected as the collaborator, identification information of user A is displayed in the collaboration window, indicated by 311 in FIG. 3D, and user A may view or edit the target document.

In one embodiment, the operation permission of user A on the target document may be set by the creator through the collaboration window 32. For example, after user A is selected as the collaborative user, the identification information 311 of user A is displayed in the collaboration window 32. The identification information 311 corresponds to one operation permission setting option 322. The operation permission of user A on the target document may be set by triggering the operation permission setting option, for example, “can view” or “can edit,” or user A is removed from the collaborators of the target document, as shown in FIG. 3E.

It is to be understood that the above introduces how to set the collaborator and a collaborator operation permission by only taking a text document as an example. For a sheet document or a presentation document, methods for setting a collaborator and an operation permission of the collaborator are similar to those for the text document, which will not be elaborated in this application.
S202: Display, in response to an image generation trigger event, a matching image that matches the target document. An image appearance attribute of the matching image characterizes semantic information of the target document, and an image content attribute of the matching image characterizes document content in the target document.

The image generation trigger event is to trigger an event of generating an image for the target document. Optionally, the image generation trigger event may be input through the document editing interface, and is used for triggering to generate an image for the target document. The matching image is used for characterizing the target document. Core content in the target document may be intuitively reflected through the matching image, which makes a user understand the target document quickly. The image appearance attribute refers to an appearance characteristic of the matching image, which may specifically include various appearance elements, for example, color theme, a size, a style, and a sticker. The image appearance attribute may characterize semantic information of the target document, that is, characterize document semantics of the target document. The image content attribute refers to a content characteristic of the matching image, which may specifically include an image main body, an image structure, image text, and the like. The image content attribute may characterize document content in the target document, such as document text, and a text title. The matching image may characterize the target document through the image appearance attribute and the image content attribute. Different target documents may correspond to different matching images, so that the target document can be accurately characterized through a matched matching image, and the user can quickly understand core content of the target document through an intuitive matching image.

Specifically, the image processing device may detect the image generation trigger event for the target document, for example, detecting whether a user triggers, for the target document, a triggering operation of sharing in a form of images. The image processing device displays a matching image that matches the target document in response to a detected image generation trigger event. The image appearance attribute of the matching image characterizes the semantic information of the target document, and the image content attribute characterizes the document content in the target document, so that the target document is adaptively characterized through the image appearance attribute and the image content attribute of the matching image.

In embodiments of this application, a document editing interface is displayed. The document editing interface may be configured to edit the target document. A matching image that matches the target document is displayed if an image generation trigger event is detected. Specifically, a matching image appearance attribute may be designed based on the semantic information of the target document in the document editing interface, a matching image content attribute may be designed based on the document content in the target document, and finally, typesetting processing may be performed on the image appearance attribute and the image content attribute to generate a matching image that matches the target document. It can be seen that the matching image is automatically generated without user involvement. Compared with the related technology, a user operation is simplified, and the design of the matching image refers to the semantic information of the target document and the document content in the target document. The user may intuitively and quickly acquire central content of the target document through the matching image, thereby facilitating the improvement of the efficiency of reading the target document by the user.

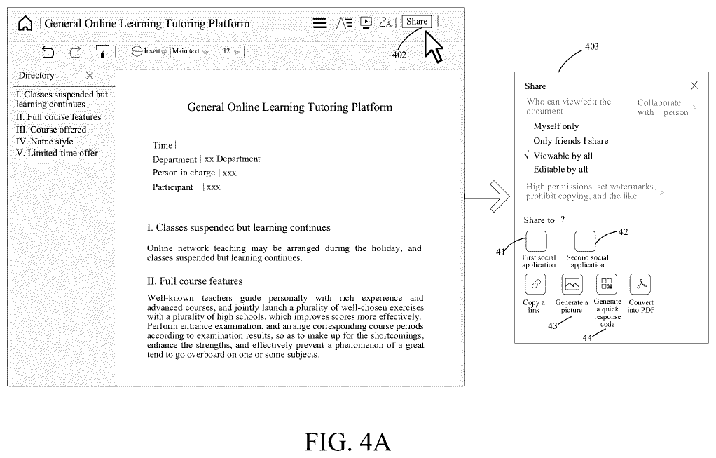

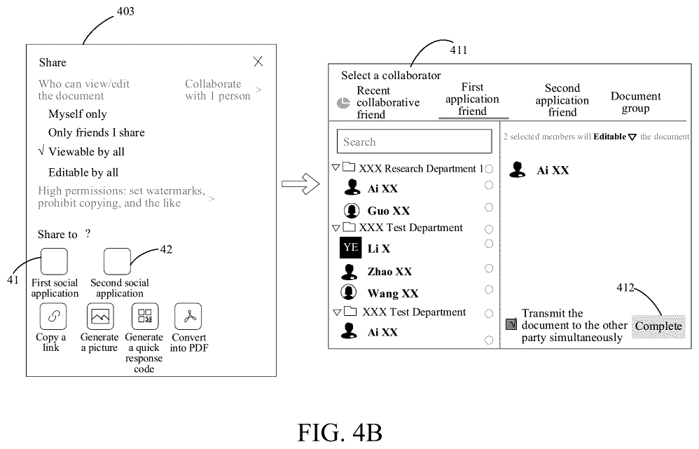

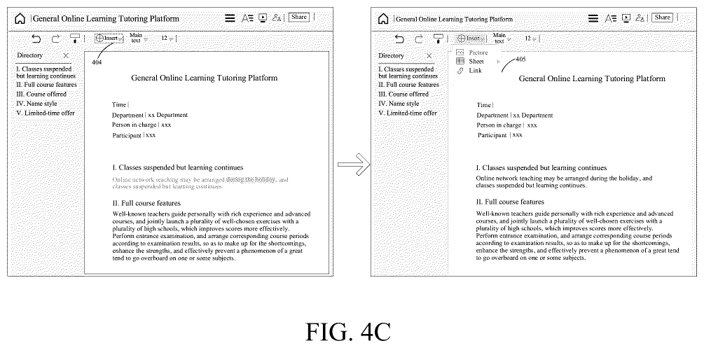

In one embodiment, the image generation trigger event may be generated by a sharing operation for sharing the target document in a form of images. For example, assuming that the document editing interface in FIG. 3A includes a sharing option 402, a sharing window, indicated by 403 in FIG. 4A, is displayed when the sharing option 402 is triggered. The sharing window 403 may include buttons corresponding to a plurality of sharing modes, for example, sharing through a first social application 41, sharing through a second social application 42, sharing in a form of images 43, and sharing in a form of information code (for example, quick response code) 44. If the button 43 corresponding to sharing in a form of images is selected, it is determined that there is a sharing operation for sharing the target document in a form of images, and the image generation trigger event is generated.

In another embodiment, the image generation trigger event may also be generated by an adding operation for adding a cover to the target document. As an optional implementation, if the target document is a sheet document, the document content in the target document includes text content. The text content includes a text title. For example, with reference to FIG. 3B, if the target document is a sheet document, the sheet document includes a document title, which is represented as “xx Rainstorm Emergency Assistance Channel,” and the target document includes a header image adding option, indicated by 401 in FIG. 3B. The adding operation for adding a cover to the target document may be that: the header image adding option in the target document is triggered, that is, if the header image adding option 401 in FIG. 3B is triggered, it is determined that there is a trigger event for generating an image, that is, the image generation trigger event is generated.

As another optional implementation, the adding operation for adding the cover to the target document may also refer to: sharing the target document to users in a social application in a form of an online document. For example, as shown in FIG. 4A, the sharing window 403 may be displayed by triggering the sharing option 402. The sharing window 403 includes a first social application 41 and a second social application 42. When any social application is triggered, a corresponding user selection window is displayed, and the user selection window includes an identifier of at least one friend user in a corresponding social application. When the identifier of any friend user is selected and it is determined that a sharing button is triggered, it is determined that the target document is shared with a selected user in the social application in the form of the online document. For example, with reference to FIG. 4B, the first social application is triggered in the sharing window 403, and a friend selection window 411 is displayed. If the identifier of Guo XX in the friend selection window 411 is selected and it is determined that the sharing button 412 is triggered, it is determined that the target document is shared with the user in the social application in the form of the online document.

In still another embodiment, the image generation trigger event may also refer to an inserting operation for inserting an image in the target document. For example, the document editing interface is as shown in FIG. 4C. The document editing interface includes a data insertion option 404. When target content of the target document is selected, for example, “during the holiday” is selected, and when the data insertion option is triggered, a data insertion window is displayed, indicated by 405 in FIG. 4C. When a “picture” in the data insertion window is selected, it is determined that there is an image generation trigger event.

Optionally, the image generation trigger event may also be generated by operating a physical component of an image processing device, for example, double-clicking a screen of the image processing device, or pressing a physical button of the image processing device.

In one embodiment, when it is detected that there is an image generation trigger event by the image processing device, the step that of a matching image that matches the target document is displayed in response to an image generation trigger event includes: whether a matching image that matches a target document has been stored locally is queried; if the matching image that matches the target document has been stored locally, the matching image is acquired locally and is displayed; if the matching image that matches the target document has not been stored locally, semantic analysis is performed on the target document, and semantic information of the target document is determined; an image appearance attribute is determined based on image attribute reference information and semantic information of the target document, and an image content attribute is determined based on document content in the target document; and typesetting processing is performed on the image appearance attribute and the image content attribute to generate the matching image, and the matching image is displayed.

The matching image and a document corresponding to the matching image may be stored locally. After the image generation trigger event is detected, and if a matching image is searched from local storage, similarity comparison may be performed on the document that is stored locally and corresponds to the matching image and the current target document; if the similarity between the two documents is greater than a similarity threshold value, the searched matching image may be displayed as a matching image that matches the target document; if the similarity between the two documents is less than or equal to a similarity threshold value, a matching image may be regenerated for the target document again. It is to be understood that if the similarity between the two documents is greater than the similarity threshold value, it indicates that the two documents are very similar, and the matching image corresponding to an existing document can also be used for reflecting central content of the target document. At this moment, in order to save the power consumption for generating images, the matching image of the existing document may be directly taken as the matching image of the target document. On the contrary, if the similarity between the two documents is less than or equal to the similarity threshold value, it indicates that the two documents are not very similar. At this moment, the matching image corresponding to an existing document cannot accurately reflect the content and theme of the target document, so a matching image that matches the target document needs to be regenerated.

Various image appearance attributes and semantic information corresponding to each image appearance attribute may be specified in image attribute reference information. Therefore, some image appearance attributes that match the target document may be determined based on the image attribute reference information and the semantic information. In other words, the determined image attribute reference information is consistent with the semantic information of the target document, and the semantic information of the target document may be characterized through the determined image appearance attribute.

In specific implementation, the image appearance attribute may include at least one of a first attribute or image color theme, and the first attribute may include at least one of the following: a sticker element, a character style, an image size, an image shape, or an image background; and the semantic information of the target document may include at least one piece of the following content: an image theme corresponding to the target document or a target emotion reflected by the target document.

The sticker element refers to an interface element in a sticker type in a matching image. The character style refers to a text style in the matching image. The image size reflects an image size of the matching image. The image shape is a shape of the matching image. The image background refers to a background of the matching image. The image color theme refers to various colors configured in the matching image. The target emotion specifically refers to the emotion of a user that edits the target document, such as excited, joyful, sad, and angry. The image theme corresponding to the target document refers to generating an image style that is in accord with the matching image that matches the target document. The image style may include luxury, fashionable, cute, fresh, cool, festive, retro, formal, and so on.

In this embodiment, at least one of the image theme or the target emotion of the target document is characterized by one of the intuitive image appearance attributes of the matching image, including the sticker element, the character style, the image size, the image shape, image color theme, or the image background, so that the image theme or the target emotion of the target document can be intuitively represented by using the image appearance attribute, thereby facilitating the improvement of the efficiency of reading the target document by the user.

In one embodiment, the image appearance attribute includes a first attribute, the image attribute reference information specifies a hashtag corresponding to the first attribute, and the semantic information of the target document includes an image theme corresponding to the target document. The image appearance attribute of the matching image characterizing the semantic information of the target document, which includes: the hashtag corresponding to the first attribute is a target hashtag that matches the image theme corresponding to the target document.

The first attribute includes at least one of a sticker element, a character style, an image size, an image shape, or an image background. The first attribute corresponds to one hashtag, that is, different first attributes may correspond to different hashtags, so that the corresponding first attribute may be represented through the hashtag. For example, the hashtag corresponding to the first attribute is fashion, and the image theme corresponding to the target document is trend, then it may be considered that the hashtag of the first attribute matches the image theme of the target document, that is, the first attribute of the matching image can accurately characterize the semantic information of the target document.

In this embodiment, the hashtag of the matching image characterizes the semantic information of the target document by making the target hashtag of the target document consistent with the hashtag of the matching image, so that the image theme or the target emotion of the target document can be intuitively characterized by using the hashtag of the matching image, thereby facilitating the improvement of the efficiency of reading the target document by the user.

In yet another embodiment, the image appearance attribute includes image color theme. The image attribute reference information indicates that the image color theme corresponds to one emotion, and the semantic information of the target document includes the target emotion reflected by the target document. The image appearance attribute of the matching image characterizes the semantic information of the target document, which includes: there is an emotion that matches the target emotion reflected by the target document in at least one emotion corresponding to the image color theme.

The image color theme refers to the colors configured for the matching image, which may specifically be a theme color configured for the matching image. The image appearance attribute being consistent with the semantic information of the target document may refer to that the emotion corresponding to the image color theme matches the target emotion reflected by the target document, so that a user emotion reflected by the target document can be intuitively characterized by the image color theme of the matching image. For example, assuming that the emotion corresponding to the image color theme is happy, and the target emotion reflected by the target document is jolly, the emotion corresponding to the image color theme matches the target emotion reflected by the target document.

In one embodiment, the image appearance attribute includes image color theme. The image attribute reference information includes a correspondence between the image color theme and the emotion. The semantic information of the target document includes the target emotion reflected by the target document. The step that the image appearance attribute is determined based on image attribute reference information and the semantic information includes: The image color theme that matches the target emotion is acquired based on the correspondence between the image color theme and the emotion.

Specifically, the image processing device may acquire the correspondence between the image color theme and the emotion from the image attribute reference information, and determines the image color theme that matches the target emotion based on the correspondence between the image color theme and the emotion. For example, the image processing device may match the target emotion and the correspondence between the image color theme and the emotion, so as to determine the image color theme that matches the target emotion. The image color theme that matches the target emotion is determined through a preset correspondence between the image color theme and the emotion, which can ensure the accuracy and efficiency of determining the image color theme, and improve the display processing efficiency of the matching image.

Optionally, the correspondence between the image color theme and the emotion indicated in the image attribute reference information may be represented in Table 1.

TABLE 1

| Color | | | | |
|---|---|---|---|---|
| attribute | Grade | Nature of emotion | Color | Emotional response |
| Hue | Warm color | Warm and positive | Red | Excited, angry, and joyful |
| | | | Orange | Pleasant and energetic |
| | | | Yellow | Energetic, glad, and cheerful |
| | Neutral color | Calm and ordinary | Green | Calm, relaxed, and peaceful |
| | | | Purple | Restless, mysterious, and |
| | | | | gentle |
| | Cool color | Cold and negative | Dark green | Restful, melancholy, and cold |
| | | | Cyan | Quiet, lonely, and sad |
| | | | Cyan purple | Mysterious and solitary |
| Brightness | Bright | Vibrant | White | Pure and fresh |
| | Moderate | Quiet | Grey | Quiet and suppressed |
| | Dark | Cold and heavy | Black | Anxiety and gloom |
| Chroma | High | Fresh | Vermilion | Intense and enthusiastic |
| | Moderate | Relaxed and | Pink | Cute and gentle |
| | | temperate | | |
| | Low | Quiet and | Dark brown | Quiet |
| | | suppressed | | |

It can be seen from Table 1 above that one image color theme includes several color attributes, for example, hue, brightness, and chroma; the hue is divided into warm color, neutral color, and cool color; the brightness is divided into bright, moderate, and dark; and the chroma is divided into high, moderate, and low. Each color attribute may correspond to one or more colors, for example, the warm color may include red, orange, and yellow; the neutral color may include green and purple; and the cool color may include dark green, cyan, and cyan purple. In the brightness, the color corresponding to the bright may be white; the color corresponding to the moderate may be gray; the color corresponding to the dark may be black. The color corresponding to a high chroma may be vermilion; the color corresponding to a moderate chroma may be pink; and the color corresponding to a low chroma may be dark brown. Each color may correspond to one or more emotions, for example, red corresponds to excited, angry, and joyful; for still another example, pink corresponds to cute or gentle; and for yet another example, green corresponds to calm, relaxed, and peaceful. It can be seen from Table 1 that one image color theme may correspond to at least one emotion.

In this embodiment, the target emotion reflected by the target document is characterized by the image color theme of the matching image, so that the target emotion reflected by the target document can be intuitively represented by the image color theme of the matching image, thereby facilitating the improvement of the efficiency of reading the target document by the user.

In one embodiment, the image content attribute includes at least one of the following: a matching character, an image main body, or an image structure; and the document content in the target document includes at least one of content information or document layout, and the content information includes at least one of text content or content illustration.

The document content in the target document may include at least one of content information or document layout, and the content information includes at least one of text content or content illustration. The document layout includes a chapter structure or a chapter-free structure. The image content attribute may include any one or more of a matching character, an image main body, or an image structure. The matching character refers to a character included in the matching image. The image main body may be image content that is in the matching image and that is to be displayed. The image structure may include a long graph structure and a short graph structure.

In this embodiment, at least one of the content information or the document layout in the target document is characterized by one of the intuitive image content attributes of the matching image, including the matching character, the image main body, and the image structure, so that the content information or the document layout in the target document can be intuitively represented by using the image content attribute, thereby facilitating the improvement of the efficiency of reading the target document by the user.

In specific implementation, the image content attribute includes the matching character. The document content in the target document includes the content information. The content information includes the text content or the content illustration. The image content attribute of the matching image characterizes the document content in the target document, which includes: the matching character includes the character content in the target document, and the matching character includes a character contained in the content illustration. The character content in the target document and the character in the content illustration are characterized by the matching character of the matching image, so that the character content of the document content in the target document can be displayed through the matching image, thereby facilitating the improvement of the efficiency of reading the target document by the user.

In one embodiment, the image content attribute includes the image main body. The document content in the target document includes the content information. The content information includes the content illustration. The image content attribute of the matching image characterizes the document content in the target document, which includes: the image main body includes a target object in the content illustration.

The target object in the content illustration may be a face, or may be any object. The image content attribute being consistent with the document content in the target document refers to that the image main body includes the target object in the content illustration, that is, the target object included in the content illustration in the target document is characterized through the image main body in the matching image, so that a user may directly determine the target object included in the content illustration in the target document according to the image main body in the intuitive matching image, thereby facilitating the improvement of the efficiency of reading the target document by the user.

In one embodiment, the image content attribute includes the image structure. The image structure corresponds to one document layout. The image content attribute of the matching image characterizes the document content in the target document, which includes: the document layout corresponding to the image structure is the same as the document layout of the target document.

The image content attribute being consistent with the document content in the target document refers to that the document layout corresponding to the image structure is the same as the document layout of the target document, that is, the document layout of the target document is characterized by the image structure of the matching image, so that the user quickly understands the document layout of the target document according to the image structure of the matching structure, thereby facilitating the improvement of the efficiency of reading the target document by the user.

In one embodiment, the image generation trigger event includes at least one of the following: an adding operation for adding a cover for the target document, a sharing operation for sharing the target document in a form of images, or an inserting operation for inserting an image in the target document.

The adding operation for adding the cover for the target document refers to a user triggered operation for adding an image as a cover for the target document. The sharing operation for sharing the target document in a form of images refers to an operation for sharing the target document, specifically, sharing the target document in the form of images. The inserting operation for inserting an image in the target document refers to processing for inserting an image for the target document.

Specifically, when the user triggers adding the cover for the target document, the image generation trigger event may be generated, so that the generated matching image is taken as the cover of the target document. When the user triggers sharing for the target document, specifically, when the user shares the target document in a form of pictures, the image generation trigger event may be generated, so that the generated matching image is taken as the image when sharing the target document. When the user inserts an image for the target document, the image generation trigger event may be generated to insert the generated matching image into the target document.

In this embodiment, during the adding operation for adding the cover for the target document, the sharing operation for sharing the target document in the form of images, or the inserting operation for inserting the image in the target document, the image generation trigger event may be generated to display the matching image that matches the target document, various application scenes may be supported, and central content of the target document is characterized through the matching image in various application scenes, thereby facilitating the improvement of the efficiency of reading the target document by the user.

In one embodiment, the document content in the target document includes text content, the text content includes a document title, the image content attribute of the matching image that matches the target document is consistent with the document title in the target document, and the step that a matching image that matches the target document is displayed in response to an image generation trigger event includes at least one of the following: a matching image that matches the target document is displayed in response to a trigger operation for a header image adding option to the target document; and a matching image that matches the target document is displayed in response to a sharing trigger operation for the target document.

An image content attribute of the matching image is consistent with the document title in the target document, so that the document title in the target document may be intuitively characterized through the image content attribute of the matching image. The header image adding option is an operation entrance for adding a header image. The header image may be an image displayed at a document header location in the target document.

Specifically, the computer device generates an image generation trigger event in response to a trigger operation for the header image adding option in the target document, that is, when a user triggers an operation for the header image adding option of the target document, and the computer device displays a matching image that matches the target document. In addition, if the user triggers the sharing operation for the target document, the image generation trigger event may also be generated, and the computer device displays the matching image that matches the target document. The image content attribute that is of the matching image and that is displayed by the computer device is consistent with the document title in the target document. In this embodiment, when the user triggers the operation for the header image adding option of the target document, or shares for the target document, the matching image that matches the target document is displayed, and the image content attribute of the matching image is consistent with the document title in the target document, so that the document title in the target document may be intuitively characterized through the image content attribute of the matching image, thereby facilitating the improvement of the efficiency of reading the target document by the user.

The image processing device performs, after determining the image appearance attribute and the image content attribute, typesetting processing on the two attributes to obtain the matching image that matches the target document, and displays the matching image. As an optional implementation, there may be one or more matching images, so that the user may further select according to actual needs.

In one embodiment, the step that a matching image that matches the target document is displayed in response to an image generation trigger event includes: an image selection window is displayed in a document editing interface in response to an image generation trigger event, and the image selection window includes at least one candidate matching image that matches the target document; and the matching image selected by the selection operation in the document editing interface is displayed in response to a selection operation triggered with respect to the candidate matching image.

The image selection window is configured to display various candidate matching images. The candidate matching images refer to the matching images for a user to select. The user may trigger a selection operation for the candidate matching images, so as to display the selected candidate matching image as the matching image of the target document. Specifically, the computer device may select the image selection window in the document editing interface when the image generation trigger event is generated, and the image selection window may include at least one candidate matching image that matches the target document. The image selection window is configured to select a displayed candidate matching image. The computer device determines the matching image selected by a selection operation of the user in response to the selection operation triggered by the user in the candidate matching image, and displays the matching image in the document editing interface.

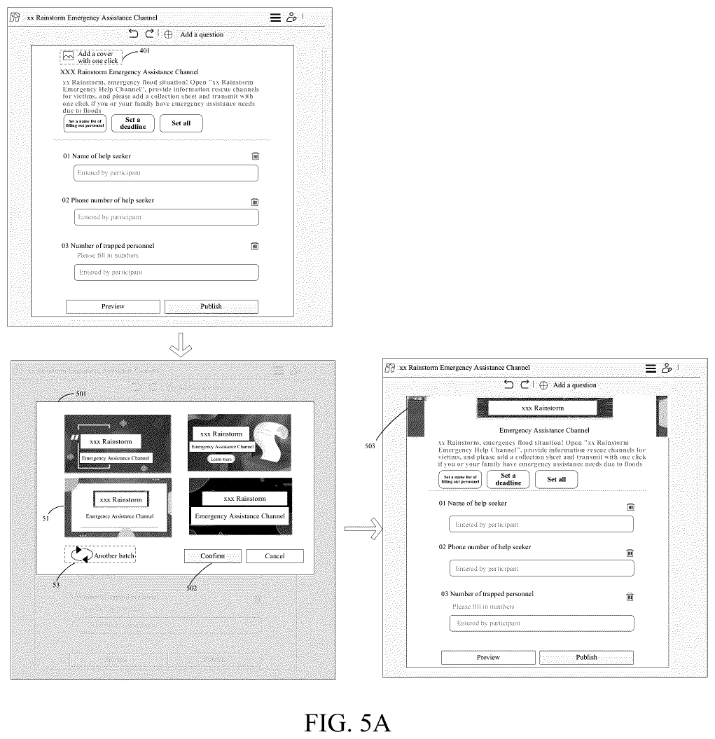

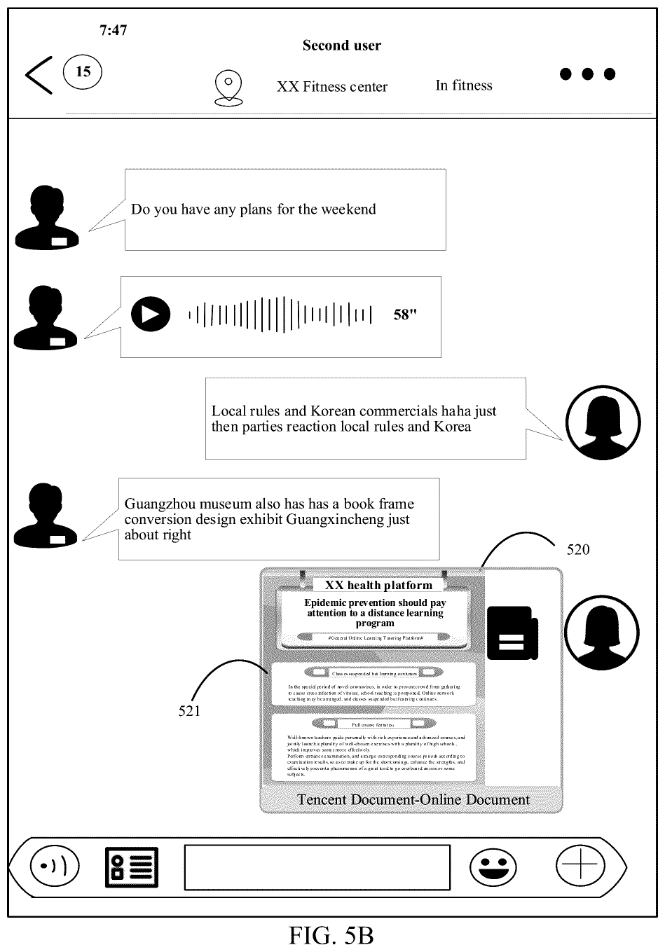

For example, assuming that the document editing interface is as shown in FIG. 3B, when 401 in FIG. 3B is triggered, an image selection window pops up in the document editing interface, indicated by 501 in FIG. 5A, and it is assumed that 501 includes four matching images and a selection confirmation option 502. If a matching image 51 is selected and the selection confirmation option 502 is triggered, the selected matching image 51 is displayed in the document editing interface, indicated by 503 in FIG. 5A. Optionally, due to limited display space, all matching images that are generated by the image processing device and match the target document may not be displayed in the image selection window at one time, the first N matching images may be displayed in the image selection window in priority according to matching degrees of all matching images from high to low, N is a positive integer greater than or equal to 1, and N is less than a total quantity of all matching images. The image selection window may include an option for switching matching images, for example, an option 53 in 501, and the user may view other matching images by triggering the option 53.

In another embodiment, if the trigger event refers to the adding operation for adding the cover to the target document, and the adding operation for adding the cover to the target document refers to sharing the target document with a user in a social application in a form of an online document, and assuming that the target document is created by a first user, and the user in the social application is a second user, then the step that the matching image that matches the target document may include: a trigger mark entering the target document is displayed in a session window of the first user and the second user of the social application, and the matching image is displayed at the trigger mark as the cover of the target document. With reference to FIG. 5B, which is another schematic diagram showing displaying a matching image provided by an embodiment of this application, FIG. 5B shows a session window that is displayed by a terminal of the first user and that is of the first user and the second user in the social application, 520 represents a trigger mark entering the target document, the target document is opened and the document editing interface of the target document is displayed when the trigger mark is selected, and 521 represents a matching image that matches the target document.

In this embodiment, at least one candidate matching image is displayed in the image selection window of the document editing interface, and the matching image selected by the selection operation of the user is displayed, which can support that the user selects as required for displaying for the candidate matching image, can ensure a close connection between the displayed matching image and the target document, and is beneficial to improving the efficiency of reading the target document of the user.

In one embodiment, the step that a matching image that matches the target document is displayed includes: a waiting animation is displayed in a process of generating the matching image; and it is switched from displaying the waiting animation to displaying the matching image that matches the target document when the generation of the matching image is completed.

The waiting animation may be determined according to core content of the target document, for example, a plurality of waiting animations are stored in the image processing device. Each waiting animation corresponds to one piece of core content, for example, a guide animation for a work report, or a funny waiting animation, or a new function recommendation animation of a document application. Specifically, the waiting animation may be displayed in the process of generating the matching image, so as to prompt the user to wait. When the generation of the matching image is completed, it is switched from displaying the waiting animation to displaying the matching image that matches the target document, so as to complete the transition from displaying the waiting animation to displaying the matching image.

In this embodiment, more information amount can be displayed through the waiting animation by prompting, through the waiting animation, the user to wait for the displaying of the matching image.

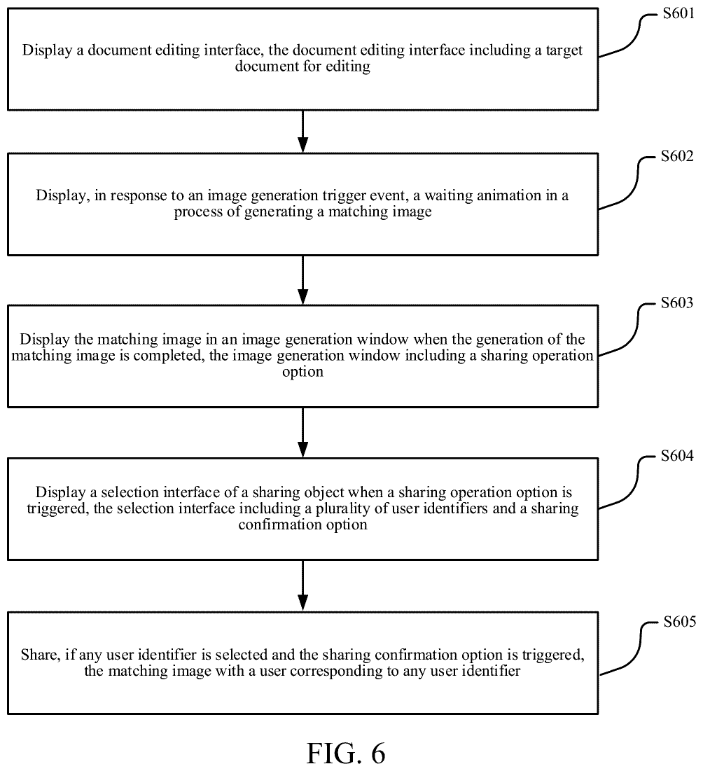

Based on the above image processing method, embodiments of this application provide another image processing method, with reference to FIG. 6, which is a schematic flowchart of another image processing method provided by embodiments of this application. The image processing method shown in FIG. 6 is performed by the image processing device. The image processing device in FIG. 6 may include the following steps:
Step S601: Display a document editing interface. The document editing interface includes a target document for editing.

Optionally, for some feasible implementations included in S601, reference can be made to a relevant description of step S201 in the embodiment of FIG. 2.
Step S602: a waiting animation is displayed, in response to an image generation trigger event, in a process of generating a matching image.

To prevent a user from getting bored during waiting for generating the matching image, a waiting animation may be displayed in a process of generating the matching image, so as to consume waiting time. The waiting animation may be determined according to core content of the target document, for example, a plurality of waiting animations are stored in the image processing device. Each waiting animation corresponds to one piece of core content, for example, a guide animation for a work report, or a funny waiting animation, or a new function recommendation animation of a document application.

In specific implementation, when an image generation trigger event is detected, the image processing device generates the matching image based on semantic information and image attribute reference information of the target document. In the process of generating the image, the image processing device simultaneously acquires the core content of the target document, then searches for the waiting animation that matches the core content from local storage, and plays the waiting animation.

Optionally, the step that the waiting animation that matches the core content is searched from the local storage includes: the waiting animation that matches the core content of the target document is searched from the local storage according to a search priority. The search priority from high to low may be: a waiting animation with the same core content as the target document, a funny waiting animation, a public welfare promotion waiting animation, and a new function introduction waiting animation. Or, the search priority from high to low may be: a waiting animation with the same core content as the target document, a new function promotion waiting animation, a public welfare promotion waiting animation, and a funny waiting animation. It is to be understood that the above is only two possible search priorities listed in embodiments of this application. In an actual application, the search priority may be set according to a specific application scene, which is not specifically limited in embodiments of this application.

In one embodiment, the steps that the waiting animation that matches the core content is searched from the local storage and the waiting animation is played include: target time required for generating the matching image is estimated; the waiting animation that matches the target time is clipped; and the clipped waiting animation is played. In this way, it can be ensured that the matching image is displayed in time after the matching image is generated.

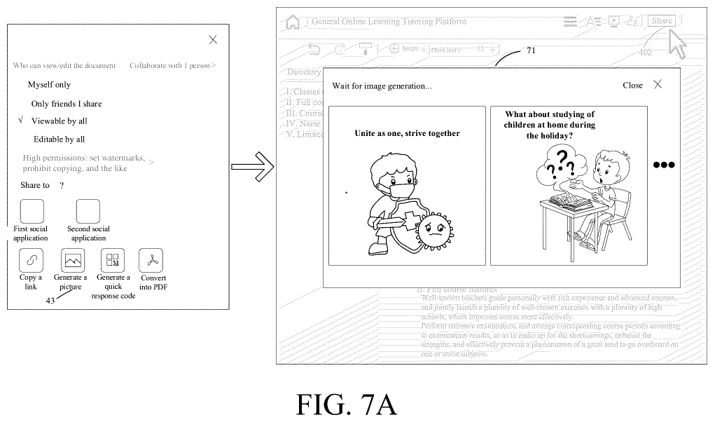

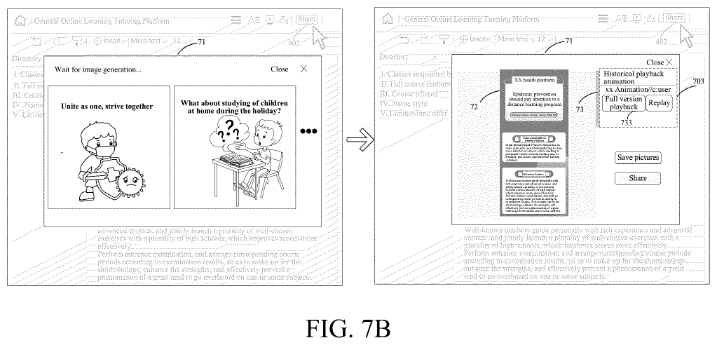

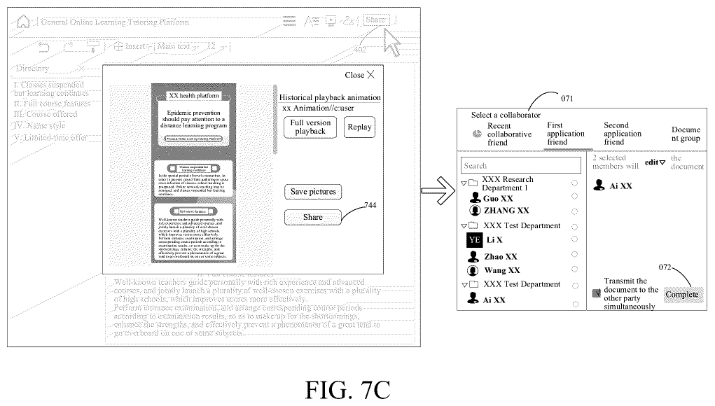

For example, assuming that it is detected that 43 is triggered in FIG. 4A, that is, there is an image generation trigger event, core content of the target document is acquired. The core content of the target document is about tutoring online, that is, related to learning, then the image processing device searches for a waiting animation related to learning from local storage, and plays the waiting animation after the waiting animation is searched, indicated by 701 in FIG. 7A, which indicates that the waiting animation is being played.
Step S603, the matching image is displayed in an image generation window when the generation of the matching image is completed. The image generation window includes a sharing operation option.

The waiting animation is to alleviate the boredom of waiting for generating the matching image. Once it is detected that the matching image has been generated, it is switched from displaying the waiting animation to displaying the matching image. Optionally, both the waiting animation and the matching image may be displayed in the image generation window. The image generation window may be superimposed on the document editing interface or may be independent.

For example, assuming that the trigger event is that 43 in FIG. 4A is triggered, the image processing device starts to generate the matching image after it is detected that 43 is triggered. In the process of generating the matching image, the waiting animation is displayed in the image generation window 71, and as time goes on and the generation of the matching image is completed, the matching image is displayed in the image generation window 71, indicated by 702 in FIG. 7B. It is to be understood that the matching image may be a long graph structure. The complete matching image cannot be completely displayed at one time in the image generation window, and only part of the matching image may be displayed. At this moment, other content of the matching image may be viewed by pulling down 73 in FIG. 7B.

It can be known from the above that the displayed waiting animation may be clipped in order to display the generated matching image in time, that is, the image processing device may not have played the completed waiting animation. However, it is not excluded that some users are interested in the played waiting animation and want to continue viewing the waiting animation. Therefore, in order to facilitate subsequent viewing of the waiting animation by the user, historical playback information of the waiting animation may be displayed when displaying the matching image, indicated by 703 in FIG. 7B. The historical playback information may include a name of the waiting animation, for example, xx animation, a storage path, for example, //c:user, and a shortcut key 733 for playing the complete waiting animation. If the user wants to continue viewing the waiting animation, the shortcut key 733 may be selected, or a storage location of the waiting animation is searched through the storage path, and the waiting animation is clicked in the storage location to start playing.
Step S604: Display a selection interface of a sharing object in case that a sharing operation option is triggered. The selection interface includes a plurality of user identifiers and a sharing confirmation option.
Step S605: Share, if any user identifier is selected and the sharing confirmation option is triggered, the matching image with a user corresponding to any user identifier.

Optionally, the window generation window may further include a sharing option, indicated by 744 in FIG. 7B, and the user may directly share the generated matching image by triggering the sharing option 744. Specifically, when the sharing option in FIG. 7B is triggered, a selection interface of a sharing object is displayed. The selection interface may be represented as 071 in FIG. 7C. The selection interface may include a plurality of user identifiers, for example, Guo XX and an avatar of Guo XX in a first social application, and Ai XX and an avatar of Ai XX in the first social application. The selection interface may also include a sharing confirmation option, indicated by 072 in FIG. 7C. Assuming that the user identifier of Ai XX is selected and the sharing confirmation option is triggered, the matching image is transmitted to Ai XX through the first social application. In the existing sharing mode, generally, after the matching image is generated, the user manually saves the matching image, then the matching image is found from the storage path of the matching image, a social application is opened, and the matching image is transmitted to a certain user through a session window with the certain user in the social application. It can be seen that, compared with the existing sharing mode, according to this application, the matching image may be shared with the certain user with one click while displaying the matching image after the matching image is generated, the sharing operation of the user is simple, and the sharing efficiency is improved.

In embodiments of this application, a document editing interface is displayed. The document editing interface may be configured to edit the target document. If there is an image generation trigger event, a matching image appearance attribute may be designed according to the semantic information of the target document in the document editing interface, a matching image content attribute may be designed according to the document content in the target document, and finally, typesetting processing may be performed on the image appearance attribute and the image content attribute to generate a matching image that matches the target document. It can be seen that the matching image is automatically generated without user involvement. Compared with the related technology, a user operation is simplified, and the design of the matching image refers to the semantic information of the target document and the document content in the target document. The user may intuitively and quickly acquire central content of the target document through the matching image, thereby facilitating the improvement of the efficiency of reading the target document by the user.

Moreover, in a process of generating the matching image, waiting time may be consumed by playing the waiting animation, and user experience is improved, so as to further increase the attention and preference of the user for the document application. In addition, after the matching image is obtained, the matching image may be shared with a specified user with one click, which realizes quick sharing, and improves the sharing efficiency.

In one embodiment, the image generation trigger event includes a sharing operation for sharing the target document in a form of images, the matching image is displayed in the image generation window, and the image generation window includes a sharing operation option. The image processing method further includes: a selection interface of the sharing object is displayed in response to a trigger operation for the sharing operation option, and the selection interface includes a plurality of user identifiers; and the matching image is shared, in response to a selection operation for the plurality of user identifiers, with a user corresponding to any user identifier selected by the selection operation.

The sharing operation for sharing the target document in the form of images may be generated by the triggering of the user to a sharing control for the target document, and specifically, may be generated by the triggering of the user to the sharing operation option in the image generation window. The user identifiers are used for identifying different users, and specifically, may include various types of identifier information, such as account numbers, names, and avatars of the users.

Specifically, the matching image is displayed in the image generation window. The image generation window further includes a sharing operation option. The user may trigger the operation of the sharing operation option. The computer device displays the selection interface of the sharing object in response to the triggered operation of the user for the sharing operation option. The selection interface includes a plurality of user identifiers. The user may select for various user identifiers, so as to select an object that the target document needs to be shared with. The computer device takes, in response to a selection operation of the user for the plurality of user identifiers, a user identifier selected by the selection operation as a sharing object of the target document, and shares the matching image with a user corresponding to any user identifier selected by the selection operation, so as to realize sharing processing of the target document.

In this embodiment, it is supported that the user shares the target document with the specified sharing object by interacting sharing operation options, which can share the target document quickly, and improves the processing efficiency of document sharing.

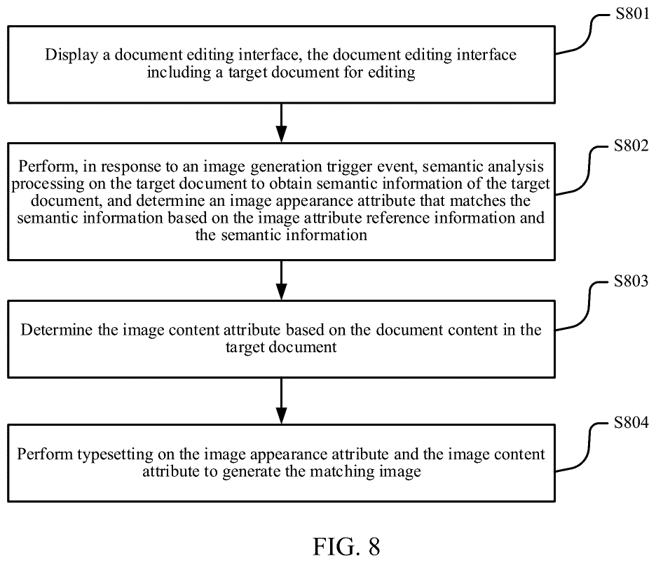

Based on the above image processing method, embodiments of this application further provide still another image processing method, with reference to FIG. 8, which is a schematic flowchart of another image processing method provided by an embodiment of this application. The image processing method shown in FIG. 8 is performed by the image processing device, and specifically, may be performed by a processor of the image processing device. The image processing method of FIG. 8 may include the following steps:
Step S801: Display a document editing interface. The document editing interface includes a target document for editing.

In one embodiment, for some feasible implementations included in S801, reference can be made to a relevant description of step S201 in the embodiment of FIG. 2.
S802: Perform, in response to an image generation trigger event, semantic analysis processing on the target document to obtain semantic information of the target document, and determine the image appearance attribute that matches the semantic information based on the image attribute reference information and the semantic information.

It can be known from the foregoing that the semantic information of the target document may include an image theme corresponding to the target document and a target emotion reflected by the target document. Optionally, semantic analysis processing is performed on the target document by using nature language processing (NLP) technology to obtain the semantic information of the target document. The NLP technology is an important direction in the field of computer science and artificial intelligence. It studies various theories and methods that can realize efficient communication between humans and computers by using a natural language. The NLP is a science that integrates linguistics, computer science, and mathematics. Therefore, the study in this field will involve the natural language, that is, the language used by people in daily life, so it is closely related to the study of linguistics. The NLP technology usually includes technologies, such as text processing, semantic understanding, machine translation, robot question answering, and knowledge mapping.

Optionally, the semantic information of the target document includes an image theme corresponding to the target document, and the step that the semantic analysis processing is performed on the target document by using the NLP technology to obtain the semantic information of the target document may include: Text content is acquired from the document content of the target document, and pre-processing is performed on the text content to obtain at least one sentence set. A sentence in each sentence set expresses semantics of the same category. Semantic analysis processing is performed on at least one sentence set, and a first sub-image theme is predicted according to a semantic analysis processing result. Semantic inference processing is performed on at least one sentence set, and a second sub-image theme is predicted according to a semantic inference processing result. An image theme corresponding to the target document is determined based on the first sub-image theme and the second sub-image theme.

There may be N sentence sets. N may be a positive integer. Each sentence set may include at least one sentence. The sentence in each sentence set expresses the semantics of the same category. The pre-processing may be the processing on the semantics of the text content, so as to cluster the sentences that express the same semantic category into the same sentence set. The semantic analysis processing refers to performing semantic analysis on the sentences in the sentence set, so as to determine the semantics specifically expressed by the sentences in the sentence set. The semantic inference processing refers to performing semantic inference on the sentences in the sentence set, so as to predict the semantics of the sentences in the sentence set. The step that the image theme corresponding to the target document is determined based on the first sub-image theme the second sub-image theme may include: The one which has higher confidence in the first sub-image theme and the second sub-image theme is taken as the image theme corresponding to the target document. Or, both the first sub-image theme and the second sub-image theme are taken as the image theme corresponding to the target document.

In this embodiment, the semantics of the text content in the target document is clustered to obtain at least one sentence set, and the semantic analysis processing and the semantic inference processing are performed on the sentence set, and the image theme corresponding to the target document is obtained by synthesizing respective results of the semantic analysis processing and the semantic inference processing, which can make full use of the semantics of the text content in the target document, and accurately determine the image theme corresponding to the target document.

It is to be understood that an image theme adding window may also be output when there is an image generation trigger event, so that a user may set a specified theme for the target document through the image theme adding window. In one embodiment, the image processing method further includes: an image theme adding window is displayed in response to an image generation trigger event, and the image theme adding window is configured to set a specified theme.

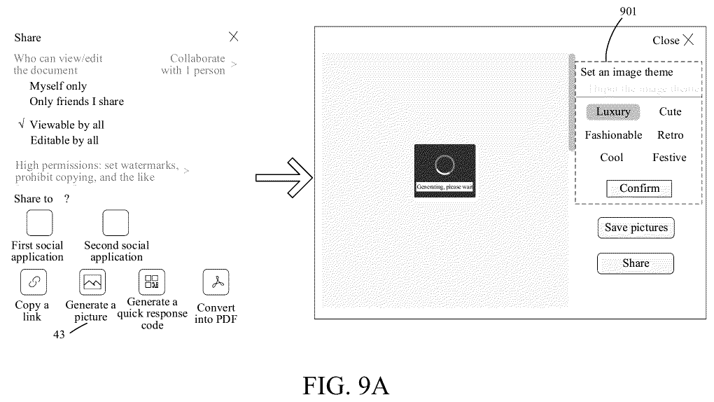

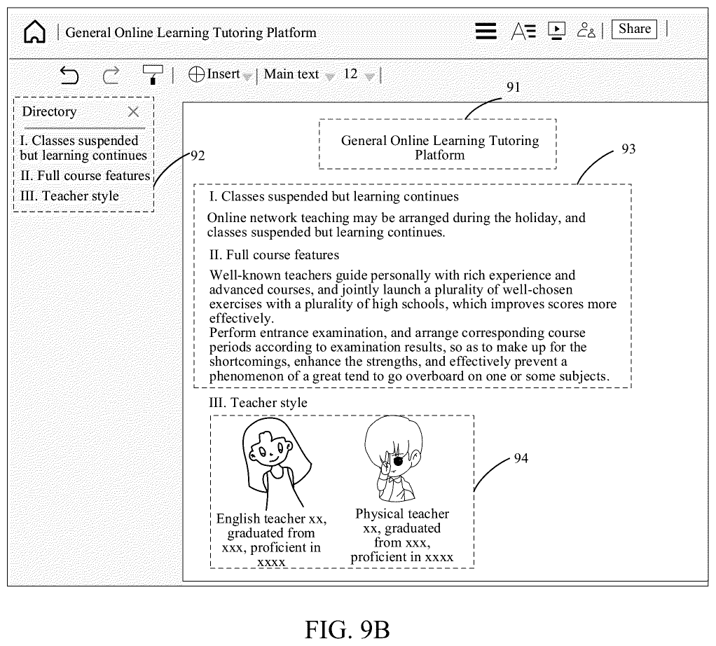

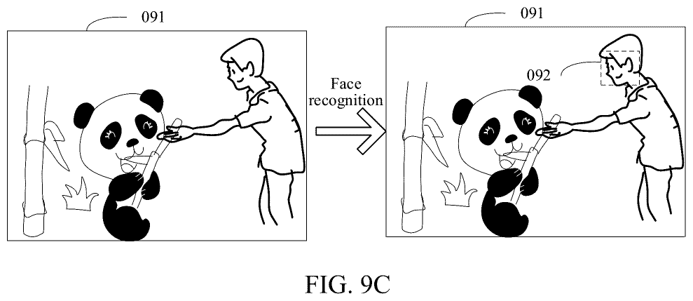

The image theme adding window is configured for a user to set the theme, and the user may actively set the specified theme for the target document according to actual needs. Specifically, with reference to FIG. 9A, which is a schematic diagram showing setting a specified theme provided by an embodiment of this application, assuming that a trigger event is input by triggering 43 in FIG. 4A, then the image processing device starts to enter a process of generating a matching image. At this moment, the image processing device may also display an image theme adding window, indicated by 901 in FIG. 9A. The image theme adding window 901 may display a plurality of hashtags specified in the image attribute reference information, such as luxury, cute, fashionable, retro, and fresh. The image theme adding window 901 may also include an input region. A user may input a new hashtag through the input region. After a specified theme is selected, a confirmation option in the image theme adding window 901 is clicked. At this moment, the image processing device determines that there is a specified theme corresponding to the target document.

In this embodiment, the image theme adding window supports the user to set the specified theme for the target document, so that the accuracy of the theme of the target document can be ensured.

In one embodiment, the image processing method further includes: when a specified theme corresponding to a target document is acquired, the specified theme is determined as an image theme of the target document; and when a specified theme corresponding to a target document is not acquired, the step that the image theme corresponding to the target document is determined based on a first sub-image theme and a second sub-image theme is performed.

Specifically, if there is the specified theme corresponding to the target document, the specified theme may be taken as the image theme of the target document, and then the step that the image theme is determined based on the first sub-image theme and the second sub-image theme does not need to be performed. If there is no specified theme corresponding to the target document, and then the step that the image theme is determined based on the first sub-image theme and the second sub-image theme may be continued to be performed.

In this embodiment, when the user sets the specified theme for the target document in advance, the specified theme may be directly determined as the image theme of the target document, otherwise, the image theme may also be automatically determined according to the first sub-image theme and the second sub-image theme, so that the image theme of the target document may be determined in a plurality of ways, thereby ensuring the accuracy of the image theme.

It is to be understood that the document content of the target document includes text content and content illustration. The text content includes a document title and main text. The target document may also include a chapter structure. In conclusion, one target document may be composed of several parts, namely, a document title, a chapter structure, main text, and a content illustration. For example, with reference to FIG. 9B, which is a schematic diagram showing a target document provided by an embodiment of this application, the target document shown in FIG. 9B includes a document title 91, a chapter structure 92, main text 93, and a content illustration 94.

Optionally, the step that pre-processing is performed on the text content of the target document to obtain N sentence sets may include: word and sentence segmentation is performed on the main text to obtain a segmentation result. Further, statement classification processing is performed on the segmentation result and the document title to obtain a plurality of sentence sets.

Optionally, the semantic information of the target document includes a target emotion reflected by the target document, and the step that semantic analysis is performed on the target document to obtain the semantic information of the target document includes: emotion analysis is performed on the at least one sentence set to obtain an emotion analysis result; and a target emotion reflected by the target document is determined according to the emotion analysis result.

The emotion analysis refers to analyzing emotions expressed by the sentences in the sentence set, and the target emotion reflected by the target document may be determined based on the emotion analysis result of the sentence set. Specifically, a computer device may perform emotion analysis on the at least one sentence set, and specifically, may perform emotion analysis on the sentence sets respectively, so as to obtain an emotion analysis result corresponding to each sentence set. The computer device may comprehensively determine the target emotion reflected by the target document according to the emotion analysis results corresponding to all sentence sets.

In this embodiment, the target emotion reflected by the target document is determined according to the emotion analysis results by performing emotion analysis on the sentences in the sentence set, so that the target emotion reflected by the target document can be accurately determined.

In one embodiment, the image appearance attribute includes a first attribute. The first attribute includes at least one of the following: a sticker element, a character style, or an image background; and the image attribute reference information includes a plurality of first attributes and a hashtag corresponding to each first attribute. The semantic information includes an image theme corresponding to the target document. The step that the image appearance attribute that matches the semantic information is determined based on the image attribute reference information and the semantic information includes: similarity matching processing is performed on the image theme and a plurality of hashtags in the image attribute reference information to determine a target hashtag; and the first attribute corresponding to the target hashtag is determined as the image appearance attribute.

Each first attribute corresponds to the hashtag. The image appearance attribute of the matching image may be determined through the hashtag. Specifically, a computer device performs similarity matching processing on the image theme and the plurality of hashtags in the image attribute reference information, specifically, may calculate the similarity between the image theme and each hashtag, and determine the target hashtag according to the similarity. The computer device may determine the hashtag that matches the image theme as a target hashtag, and may determine the hashtag with the highest similarity with the image theme as the target hashtag when determining the similarity. The computer device determines a first attribute corresponding to the hashtag, and determines the first attribute as an image appearance attribute that needs to be configured to the matching image, so that the semantic information of the target document can be characterized through the image appearance attribute of the matching image.

In this embodiment, similarity matching processing is performed on the image theme and the plurality of hashtags, and the image appearance attribute that needs to be configured to the matching image is acquired according to the first attribute corresponding to the determined hashtag, so that the accuracy of the target hashtag can be ensured, thereby ensuring that the semantic information of the target document can be accurately characterized through the image appearance attribute of the matching image.

In one embodiment, the step that the image theme corresponding to the target document is determined based on the first sub-image theme the second sub-image theme includes: both the first sub-image theme and the second sub-image theme are taken as the image theme corresponding to the target document. Further, the step that similarity matching processing is performed on the image theme and the plurality of hashtags in the image attribute reference information to determine the target hashtag includes: a first hashtag that matches the first sub-image theme is determined from the plurality of hashtags, and a matching degree corresponding to the first hashtag is determined; a second hashtag that matches the second sub-image theme is determined from the plurality of hashtags, and a matching degree corresponding to the first hashtag is determined; and the target hashtag is determined from the first hashtag and the second hashtag based on the matching degree corresponding to the first hashtag and the matching degree corresponding to the second hashtag.

The image theme corresponding to the target document includes the first sub-image theme and the second sub-image theme. The first sub-image theme and the second sub-image theme may be respectively matched with the plurality of hashtags to determine respective hashtags, and the target hashtag is determined according to the matching degree. Specifically, a computer device may match the first sub-image theme and the second sub-image theme with the plurality of hashtags respectively to determine a first hashtag that matches the first sub-image theme, a matching degree corresponding to the first hashtag, a second hashtag that matches the second sub-image theme, a matching degree corresponding to the second hashtag. The computer device may select a hashtag with high matching degree from the first hashtag and the second hashtag as the target hashtag.

In this embodiment, the first sub-image theme and the second sub-image theme are respectively matched with the plurality of hashtags, and the target hashtag is determined based on the matching degree, so that the accuracy of the target hashtag can be determined.
Step S803: Determine an image content attribute based on the document content in the target document.

In one embodiment, the document content in the target document includes the text content and the content illustration, the image content attribute includes a matching character, and the step that the image content attribute is determined based on the document content in the target document includes: word and sentence segmentation is performed on the text content to obtain a segmentation result; character recognition is performed on the content illustration to obtain a recognition result; and the segmentation result and the recognition result are added to the matching character.

It can be known from the foregoing that the document content in the target document includes content information or a document layout, and the content information may also include text content or content illustration. If the image content attribute may include a matching character, the step that the image content attribute is determined based on the document content in the target document includes: word and sentence segmentation is performed on the text content to obtain a segmentation result; the segmentation result is added to the matching character; character recognition is performed on the content illustration; and a recognition result is added to the matching character. The text content may include main text and a document title. The word and sentence segmentation performed on the text content may refer to performing word and sentence segmentation on the main text. Generally, character recognition may be performed on the content illustration through an optical character recognition (OCR) technology in computer vision (CV). The OCR refers to a process that an electronic device checks characters printed on paper, determines shapes thereof in a mode of detecting darkness and brightness, and then translates the shapes into computer characters by a character recognition method.

In this embodiment, word and sentence segmentation and character recognition are respectively performed on the text content and the content illustration in the target document, and the matching character is determined based on the segmentation result and the recognition result, so that the accuracy of the matching character in the image content attribute of the matching image can be ensured.

In one embodiment, the document content in the target document includes the content illustration, the image content attribute includes the image main body, and the step that the image content attribute is determined based on the document content in the target document includes: object recognition processing is performed on the content illustration to obtain an object recognition result; and a target object image is clipped from the content illustration when the object recognition result indicates that the content illustration includes a target object, and the target object image is added to the image main body.

If the image content attribute may include the image main body, the step that the image content attribute is determined based on the document content in the target document includes: object recognition is performed on the content illustration in the target document to obtain an object recognition result; a target object image is clipped from the content illustration if the object recognition result indicates that the content illustration includes a target object; and the target object image is added to the image main body. The target object may refer to any object, such as a face and any item. It is to be understood that the object recognition performed on the content illustration here may be performed by invoking a pre-trained image recognition model. The image recognition model may be constructed based on a CV technology, and achieves convergence by training by using a large number of training images. The image recognition model that achieves convergence may accurately recognize a specified object from one image. The CV is a science that studies how to use a machine to “see,” and furthermore, that uses a camera and a computer to replace human eyes to perform machine vision such as recognition, tracking, and measurement on a target, and further perform graphic processing, so that the computer processes the target into an image that is more suitable for human eyes to observe, or an image transmitted to an instrument for detection. As a scientific discipline, CV studies related theories and technologies and attempts to establish an AI system that can obtain information from images or multidimensional data. The CV technology typically includes technologies such as image processing, image recognition, image semantic understanding, image retrieval, OCR, video processing, video semantic understanding, video content/behavior recognition, 3-dimensional (3D) object reconstruction, 3D technology, virtual reality, augmented reality, synchronous positioning and map construction, autonomous driving, and smart transportation, and also includes common biometric recognition technologies such as face recognition and fingerprint recognition.

For example, assuming that the target object is a face, with reference to FIG. 9C, which is a schematic diagram showing a content illustration provided by an embodiment of this application, 091 represents a content illustration. Face recognition processing is performed on the content illustration 091 to determine that the content illustration includes the face, and contour position coordinates of the face are marked in the content illustration, indicated by 092, so as to clip a face image.

In this embodiment, when the content illustration of the target document includes the target object, the target object image clipped from the content illustration is added to the image content attribute of the matching image, so that the document content in the target document may be characterized by using the image content attribute of the matching image, thereby facilitating the improvement of the efficiency of reading the target document by the user.

It can be known from the foregoing that the image content attribute may further include an image structure. The image structure may include a long graph structure and a short graph structure. Related information of the document content in the target document may include a document layout. The document layout may include a chapter structure or a chapter-free structure. The step that the image content attribute is determined based on the related information of the document content in the target document may include: It is determined that the image structure is the long graph structure if the document layout of the target document is the chapter structure; and it is determined that the image structure is the short graph structure if the document layout of the target document is the chapter-free structure.
Step S804: Perform typesetting on the image appearance attribute and the image content attribute to generate the matching image.

Specifically, after determining the image appearance attribute and the image content attribute corresponding to the target document, the image processing device may perform typesetting on the image appearance attribute and the image content attribute to generate the matching image that matches the target document. The image appearance attribute of the matching image may characterize the semantic information of the target document, and the image content attribute of the matching image may characterize the document content in the target document.

In this embodiment, semantic analysis is performed on the target document to obtain the semantic information of the target document, the image appearance attribute is determined based on the image attribute reference information and the semantic information, image content attribute is determined based on the document content in the target document, typesetting is performed on the image appearance attribute and the image content attribute to generate the matching image, so that the matching image that matches the target document can be obtained, central content of the target document can be accurately expressed through the matching image, and the expressed information amount is increased.

It can be known from the foregoing that the first attribute is determined based on the semantic information of the target document. The first attribute may include an image background. The image background may be preset. However, in order to match the target document and the matching image better, after object recognition processing is performed on the content illustration, the content illustration may also be added to the image background if an object recognition result determines that the content illustration does not include the target object.

In one embodiment, the image appearance attribute includes a first attribute. The first attribute includes an image background. The image processing method further includes: the content illustration is added to the image background when the object recognition result indicates that the content illustration does not include the target object.

Specifically, the content illustration may be added to the image background when the content illustration of the target document does not include the target object, so that the content illustration of the target document may be characterized by the image background of the matching image, thereby facilitating the improvement of the efficiency of reading the target document by the user.

In one embodiment, the step that the content illustration is added to the image background when the object recognition result indicates that the content illustration does not include the target object includes: the content illustration is added to the image background when a quantity of characters contained in the content illustration is less than a quantity threshold value.

Specifically, if there are too many characters in the content illustration, a finally generated matching image is relatively chaotic when the content illustration is taken as an image background, so that the whether the quantity of characters contained in the content illustration is within a quantity threshold value range is further determined in a case that the content illustration does not include the target object. If the quantity of characters contained in the content illustration is within the quantity threshold value range, the content illustration is added to the image background. If the quantity of characters contained in the content illustration is greater than the quantity threshold value, the content illustration cannot be taken as the image background. In embodiments of this application, the image background may also include a background atmosphere. The background atmosphere is to express an atmosphere through decorative elements such as stickers or pictures, for example, to express a festive atmosphere through a Fu character sticker, and for another example, to express a serious or tense atmosphere through an exclamation point-shaped sticker.

In this embodiment, the content illustration may be added to the image background when the quantity of the characters contained in the content illustration is less than the quantity threshold value, so that the content illustration of the target document may be characterized by the image background of the matching image, thereby facilitating the improvement of the efficiency of reading the target document by the user.

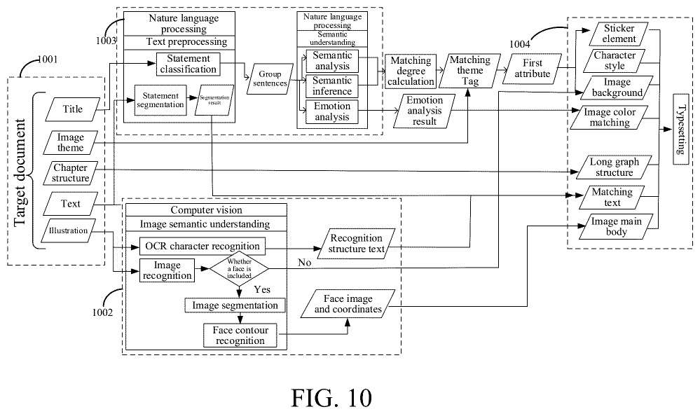

Based on a comprehensive description of step S803 and step S804, embodiments of this application provide a schematic architectural diagram showing generating a matching image provided by an embodiment of this application, with reference to FIG. 10. The schematic architectural diagram of FIG. 10 may include a raw material disassembly module 1001, a CV module 1002, an NLP module 1003, and a picture generation module 1004.

The raw material disassembly module 1001 refers to disassembling the target document, for example, disassembling a document title, a chapter structure, main text, a content illustration, and a specified theme in the target document. The CV module 1002 is mainly configured to process the content illustration in the target document. In a specific implementation, a character in the content illustration may be recognized by using the OCR, a recognition result is added to a matching character of the image content attribute, image classification and recognition are performed on the content illustration, and whether the content illustration includes a face is determined. If the content illustration includes the face, a face image is segmented from the content illustration, and the segmented face image is added to the image main body of the image content attribute. If the content illustration does not include the face, the content illustration is added to the image background in the image appearance attribute.

The NLP module 1003 is mainly configured to process the text content in the target document. The text content includes a document title and main text. In a specific implementation, word and sentence segmentation is performed on the main text to obtain a segmentation result. Then, statement classification is performed on the segmentation result and the document title to obtain some group sentences. Further, semantic analysis and semantic inference are respectively performed on these group sentences to determine a first sub-image theme and a second sub-image theme of the target document, and a target hashtag is determined according to the matching condition between the first sub-image theme and each hashtag in the image attribute reference information and between the second sub-image theme and each hashtag in the image attribute reference information. Then, a first attribute is determined based on a correspondence between the target hashtag and the first attribute. The first attribute may include a sticker element, a character style, and an image background. Emotion analysis is performed on the group sentences. Suitable image color theme is determined for the target document according to an emotion analysis result and a correspondence between an emotion included in the image attribute reference information and the image color theme.

After the image appearance attribute and the image content attribute are determined by the above NLP module and the CV module, the picture generation module 1004 perform typesetting processing based on the image appearance attribute and the image content attribute to generate a matching image.

In the related technology, when the target document is edited, we may need to add an exquisite cover image to a sheet if the target document is a sheet document. Or, an exquisite image that matches the document content also needs to be generated when we want to share the target document in a form of images. In the related technology, a process of generating an image according to the target document is complex, first, a user needs to search for a suitable image template in image design software, and then modifies and designs the image template based on the target document. It often takes 1 to 2 hours to perform typesetting and color theme, so as to design an image. The designed image is downloaded and saved, and the image is shared or inserted into the target document. However, due to limited aesthetics of the user, it is difficult for a non-professional image producer to obtain an exquisite image. Mover, pictures need to be repeatedly downloaded and uploaded by the user. In embodiments of this application, a document editing interface is displayed. The document editing interface may be configured to edit the target document. If there is an image generation trigger event, a matching image appearance attribute may be designed according to the semantic information of the target document in the document editing interface, a matching image content attribute may be designed according to the document content in the target document, and finally, typesetting processing may be performed on the image appearance attribute and the image content attribute to generate a matching image that matches the target document. It can be seen that the matching image is automatically generated based on the semantic information of the target document without user involvement. Compared with the related technology, a user operation is simplified, and the design of the matching image refers to the semantic information of the target document and the document content in the target document. The user may intuitively and quickly acquire central content of the target document through the matching image, thereby facilitating the improvement of the efficiency of reading the target document by the user.

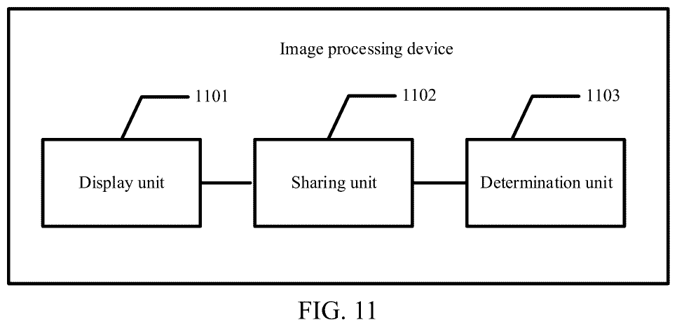

Based on the above image processing method embodiment, an embodiment of this application provides an image processing apparatus, with reference to FIG. 11, which is a schematic structural diagram of an image processing apparatus provided by embodiments of this application. The image processing apparatus shown in FIG. 11 may run the following units:
a display unit 1101, configured to display a document editing interface, the document editing interface including a target document for editing,
the display unit 1101 being further configured to display, in response to an image generation trigger event, a matching image that matches the target document, an image appearance attribute of the matching image characterizing semantic information of the target document, and an image content attribute of the matching image characterizing document content in the target document.

In one embodiment, the image appearance attribute includes at least one of a first attribute or image color theme, and the first attribute includes at least one of the following: a sticker element, a character style, an image size, an image shape, or an image background; and the semantic information of the target document includes at least one piece of the following content: an image theme corresponding to the target document or a target emotion reflected by the target document.

In one embodiment, the image appearance attribute includes a first attribute, the first attribute corresponds to a hashtag, and the semantic information of the target document includes an image theme corresponding to the target document. The hashtag corresponding to the first attribute is a target hashtag that matches the image theme corresponding to the target document.

In one embodiment, the image appearance attribute includes image color theme. The image color theme corresponds to at least one emotion, and the semantic information of the target document includes the target emotion reflected by the target document. There is an emotion that matches the target emotion reflected by the target document in at least one emotion corresponding to the image color theme.

In one embodiment, the image content attribute includes at least one of the following: a matching character, an image main body, or an image structure; and the document content in the target document includes at least one of content information or document layout, and the content information includes at least one of text content or content illustration.

In one embodiment, the image content attribute includes a matching character, the document content in the target document includes the content information, and the content information includes the text content or the content illustration. The matching character includes the character content in the target document, and the matching character includes a character contained in the content illustration.

In one embodiment, the image content attribute includes an image main body, the document content in the target document includes the content information, and the content information includes the content illustration. The image main body includes a target object in the content illustration.

In one embodiment, the image content attribute includes an image structure, and the image structure corresponds to one document layout. The document layout corresponding to the image structure is the same as the document layout of the target document.

In one embodiment, the image generation trigger event includes at least one of the following: an adding operation for adding a cover for the target document, a sharing operation for sharing the target document in a form of images, or an inserting operation for inserting an image in the target document.

In one embodiment, the document content in the target document includes text content, the text content includes a document title, the image content attribute of the matching image that matches the target document is consistent with the document title in the target document, and the display unit 1101 is also configured to display a matching image that matches the target document in response to a trigger operation for a header image adding option to the target document.

In one embodiment, the document content in the target document includes text content, the text content includes a document title, the image content attribute of the matching image that matches the target document is consistent with the document title in the target document, and the display unit 1101 is also configured to display a matching image that matches the target document in response to a sharing trigger operation for the target document.

In one embodiment, the display unit 1101 is also configured to: display an image selection window in a document editing interface in response to an image generation trigger event, the image selection window including at least one candidate matching image that matches the target document; and display the matching image selected by the selection operation in the document editing interface in response to a selection operation triggered with respect to the candidate matching image.

In one embodiment, the display unit 1101 is also configured to: display a waiting animation in a process of generating the matching image; and switch displaying the waiting animation to displaying the matching image that matches the target document when the generation of the matching image is completed.

In one embodiment, the image processing apparatus further includes a sharing unit 1102. The image generation trigger event includes a sharing operation for sharing the target document in a form of images, the matching image is displayed in the image generation window, and the image generation window includes a sharing operation option. The display unit 1101 is also configured to display a selection interface of the sharing object in response to a trigger operation for the sharing operation option, the selection interface including a plurality of user identifiers. The sharing unit 1102 is also configured to share, in response to a selection operation for the plurality of user identifiers, the matching image with a user corresponding to any user identifier selected by the selection operation.

In one embodiment, the display unit 1101 is also configured to: perform, in response to an image generation trigger event, semantic analysis on the target document to obtain semantic information of the target document, determine the image appearance attribute based on image attribute reference information and the semantic information, determine the image content attribute based on the document content in the target document; and perform typesetting on the image appearance attribute and the image content attribute to generate the matching image.

In one embodiment, the semantic information of the target document includes an image theme corresponding to the target document. The display unit 1101 is also configured to: acquire text content from the document content of the target document, and perform pre-processing on the text content to obtain at least one sentence set, a sentence in each sentence set expresses semantics of the same category; perform semantic analysis processing on at least one sentence set, and predict a first sub-image theme according to a semantic analysis processing result; perform semantic inference processing on at least one sentence set, and predict a second sub-image theme according to a semantic inference processing result; and determine an image theme corresponding to the target document based on the first sub-image theme and the second sub-image theme.

In one embodiment, the semantic information of the target document includes a target emotion reflected by the target document. The display unit 1101 is also configured to: perform emotion analysis on the at least one sentence set to obtain an emotion analysis result; and determine a target emotion reflected by the target document according to the emotion analysis result.

In one embodiment, the image processing apparatus further includes a determination unit 1103. The determination unit 1103 is configured to: determine, when a specified theme corresponding to a target document is acquired, the specified theme as an image theme of the target document; and perform, when a specified theme corresponding to a target document is not acquired, the step of determining the image theme corresponding to the target document based on a first sub-image theme and a second sub-image theme.

In one embodiment, the image appearance attribute includes a first attribute. The first attribute includes at least one of the following: a sticker element, a character style, or an image background; and the image attribute reference information includes a plurality of first attributes and a hashtag corresponding to each first attribute. The semantic information includes an image theme corresponding to the target document. The display unit 1101 is also configured to: perform similarity matching processing on the image theme and a plurality of hashtags in the image attribute reference information to determine a target hashtag; and determine the first attribute corresponding to the target hashtag as the image appearance attribute.

In one embodiment, the display unit 1101 is also configured to: take both the first sub-image theme and the second sub-image theme as the image theme corresponding to the target document; determine a first hashtag that matches the first sub-image theme from the plurality of hashtags, and determine a matching degree corresponding to the first hashtag; determine a second hashtag that matches the second sub-image theme from the plurality of hashtags, and determine a matching degree corresponding to the first hashtag; and determine the target hashtag from the first hashtag and the second hashtag based on the matching degree corresponding to the first hashtag and the matching degree corresponding to the second hashtag.

In one embodiment, the display unit 1101 is also configured to: display an image theme adding window in response to an image generation trigger event, and the image theme adding window is configured to set a specified theme.

In one embodiment, the image appearance attribute includes image color theme. The image attribute reference information includes a correspondence between the image color theme and the emotion, and the semantic information of the target document includes the target emotion reflected by the target document. The display unit 1101 is also configured to acquire the image color theme that matches the target emotion based on the correspondence between the image color theme and the emotion.

In one embodiment, the document content in the target document includes the text content and the content illustration, and the image content attribute includes a matching character. The display unit 1101 is also configured to: perform word and sentence segmentation on the text content to obtain a segmentation result; perform character recognition on the content illustration to obtain a recognition result; and add the segmentation result and the recognition result to the matching character.

In one embodiment, the document content in the target document includes the content illustration, and the image content attribute includes an image main body. The display unit 1101 is also configured to: perform object recognition processing on the content illustration to obtain an object recognition result; clip a target object image from the content illustration when the object recognition result indicates that the content illustration includes a target object, and add the target object image to the image main body.

In one embodiment, the image appearance attribute includes a first attribute. The first attribute includes an image background. The display unit 1101 is also configured to add, when the object recognition result indicates that the content illustration does not include a target object, the content illustration to the image background.

In one embodiment, the display unit 1101 is also configured to: add, when a quantity of characters contained in the content illustration is less than a quantity threshold value, the content illustration to the image background.

According to one embodiment of this application, various steps involved in the image processing methods shown in FIG. 2, FIG. 6, and FIG. 8 may be performed by various units of the image processing apparatus shown in FIG. 11. For example, steps S201 and S202 shown in FIG. 2 may be performed by the display unit 1101 in the image processing apparatus shown in FIG. 11. For another example, steps S601 to S604 shown in FIG. 6 may be performed by the display unit 1101 in the image processing apparatus shown in FIG. 11, and step S605 in FIG. 6 may be performed by a sharing unit 1102 in the image processing apparatus shown in FIG. 11. For still another example, steps S801 and S804 shown in FIG. 8 may be performed by the display unit 1101 in the image processing apparatus shown in FIG. 11, steps S802 and S803 may be performed by the determination unit 1103 in the image processing apparatus shown in FIG. 11.

According to another embodiment of this application, units of the image processing apparatus shown in FIG. 11 may be separately or wholly combined into one or several other units, or one (or more) of the units therein may further be divided into a plurality of units of smaller functions. In this way, same operations can be implemented with affecting the achievement of the technical effects of embodiments of this application. The foregoing units are divided based on logical functions. In an actual application, a function of one unit may also be implemented by a plurality of units, or functions of a plurality of units are implemented by one unit. In other embodiments of this application, the image processing apparatus may also include other units. In an actual application, these functions may also be cooperatively implemented by other units and may be cooperatively implemented by a plurality of units.

According to another embodiment of this application, an image processing apparatus shown in FIG. 11 may be constructed and an image processing method may be implemented by running a computer-readable instruction (including program code) that can perform various steps involved in corresponding methods shown in FIG. 2, FIG. 6, and FIG. 8 on processing elements and memory elements including a central processing unit (CPU), a random access memory (RAM), a read-only memory (ROM), and so on, for example, generic computing devices of computers. The computer-readable instruction may be recorded in, for example, a computer-readable storage medium, and may be loaded and run in an image processing device through the computer-readable storage medium.

In embodiments of this application, a document editing interface is displayed. The document editing interface may be configured to edit the target document. If there is an image generation trigger event, a matching image appearance attribute may be designed according to the semantic information of the target document in the document editing interface, a matching image content attribute may be designed according to the document content in the target document, and finally, typesetting processing may be performed on the image appearance attribute and the image content attribute to generate a matching image that matches the target document. It can be seen that the matching image is automatically generated without user involvement. Compared with the related technology, a user operation is simplified, and the design of the matching image refers to the semantic information of the target document and the document content in the target document. The user may intuitively and quickly acquire central content of the target document through the matching image, thereby facilitating the improvement of the efficiency of reading the target document by the user.

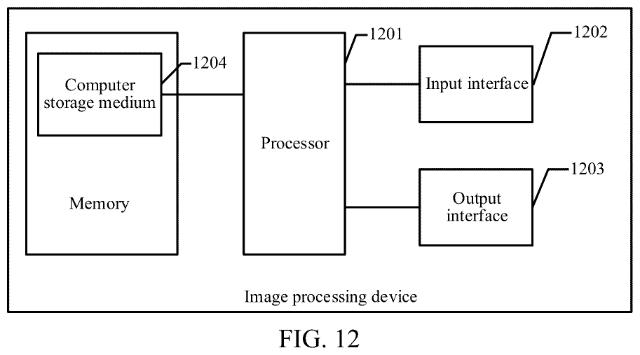

Based on the embodiments of the above image processing method and the embodiments of the image processing apparatus, the embodiments of this application provide an image processing device, with reference to FIG. 12, which is a schematic structural diagram of an image processing device provided by the embodiments of this application. The image processing device shown in FIG. 12 may include a processor 1201, an input interface 1202, an output interface 1203, and a computer storage medium 1204. The processor 1201, the input interface 1202, the output interface 1203, and the computer storage medium 1204 may be connected through a bus or in other modes.

The computer storage medium 1204 may be stored in a memory of the image processing device. The computer storage medium 1204 is configured to sore a computer readable instruction. The processor 1201 is configured to execute the computer readable instruction stored in the computer storage medium 1204. The processor 1201 (which may alternatively be referred to as a central processing unit (CPU)) is a computing core and a control core of the image processing device, which is suitable for implementing one or more computer-readable instructions, and specifically suitable for loading and performing various steps of the above image processing method.

In embodiments of this application, a document editing interface is displayed. The document editing interface may be configured to edit the target document. If there is an image generation trigger event, a matching image appearance attribute may be designed based on the semantic information of the target document in the document editing interface, a matching image content attribute may be designed based on the document content in the target document, and finally, typesetting processing may be performed on the image appearance attribute and the image content attribute to generate a matching image that matches the target document. It can be seen that the matching image is automatically generated without user involvement. Compared with the related technology, a user operation is simplified, and the design of the matching image refers to the semantic information of the target document and the document content in the target document. The user may intuitively and quickly acquire central content of the target document through the matching image, thereby facilitating the improvement of the efficiency of reading the target document by the user.

An embodiment of this application further provides a computer storage medium (memory). The computer storage medium is a memory device in the image processing device, and is configured to store a computer-readable instruction and data. It is to be understood that the computer storage medium here may include a built-in memory of an image processing device, of course, an extended storage medium supported by the image processing device. The computer storage medium provides storage space. The storage space stores an operating system of the image processing device. In addition, the storage space further stores one or more computer-readable instructions that are suitable to be loaded and executed by the processor 1201. The computer-readable storage medium here may be a high-speed RAM memory, or a non-volatile memory, for example, at least one magnetic disk memory. Optionally, the memory may also be at least one computer storage medium that is located far away from the foregoing processor.

In one embodiment, one or more computer-readable instructions stored in the computer storage medium may be loaded by a processor 901 to perform various steps in the above image processing method.

An embodiment of this application provides a computer program product. The computer program product includes a computer-readable instruction. The computer-readable instruction, when executed by a processor 1201, is used for loading and performing various steps of the above image processing method.

The technical features of the above embodiments may be arbitrarily combined. For the sake of brevity of description, all possible combinations of the technical features in the above embodiments are not described. However, as long as there is no contradiction in the combination of these technical features, it is considered to be the range described in this specification.

The above embodiments are merely illustrative of several implementations of this application with specific and detailed description, and are not to be construed as limiting the patent scope of this application. A number of variations and modifications may be made by those of ordinary skill in the art without departing from the conception of this application, and all fall within the scope of protection of this application. Therefore, the scope of protection of this application shall be subject to the appended claims.

What is claimed is:

1. An image processing method, performed by a computer device, comprising:
displaying a document editing interface, the document editing interface including a target document; and
displaying, in response to an image generation trigger event, a matching image that matches the target document, an image appearance attribute of the matching image characterizing semantic information of the target document, and an image content attribute of the matching image characterizing document content in the target document.

2. The method according to claim 1, wherein:
the image appearance attribute includes at least one of a first attribute or image color matching, and the first attribute includes at least one of a sticker element, a character style, an image size, an image shape, or an image background; and
the semantic information of the target document includes at least one of an image theme corresponding to the target document or a target emotion reflected by the target document.

3. The method according to claim 2, wherein:
the image appearance attribute includes the first attribute, the first attribute corresponds to a hashtag, the semantic information of the target document includes an image theme corresponding to the target document, and the hashtag corresponding to the first attribute matches the image theme corresponding to the target document; and/or
the image appearance attribute includes the image color theme, the image color theme corresponds to at least one emotion, the semantic information of the target document includes the target emotion reflected by the target document, and the at least one emotion corresponding to the image color theme includes an emotion that matches the target emotion reflected by the target document.

4. The method according to claim 1, wherein:
the image content attribute includes at least one of a matching character, an image main body, or an image structure; and
the document content in the target document includes at least one of content information or document layout, and the content information includes at least one of text content or content illustration.

5. The method according to claim 4, wherein:
the image content attribute includes a matching character, the document content in the target document includes the content information, the content information includes the text content and the content illustration, the matching character includes the character content in the target document, and the matching character includes a character contained in the content illustration;
the image content attribute includes an image main body, the document content in the target document includes the content information, the content information includes the content illustration, and the image main body includes a target object in the content illustration; and/or
the image content attribute includes an image structure, and a document layout corresponding to the image structure is same as the document layout of the target document.

6. The method according to claim 1, wherein the image generation trigger event includes at least one of an adding operation for adding a cover for the target document, a sharing operation for sharing the target document in a form of images, or an inserting operation for inserting an image in the target document.

7. The method according to claim 1, wherein:
the document content in the target document includes text content, the text content includes a document title, the image content attribute of the matching image is consistent with the document title; and
displaying, in response to the image generation trigger event, the matching image includes displaying the matching image in response to at least one of:
a trigger operation for a header image adding option, or
a sharing trigger operation for the target document.

8. The method according to claim 1, wherein displaying, in response to the image generation trigger event, the matching image includes:
displaying, in response to the image generation trigger event, an image selection window in a document editing interface, the image selection window including at least one candidate matching image that matches the target document; and
displaying, in response to a selection operation triggered with respect to the at least one candidate matching image, one of the at least one matching image selected by the selection operation in the document editing interface as the matching image.

9. The method according to claim 1, wherein displaying the matching image includes:
displaying a waiting animation in a process of generating the matching image; and
switching, in response to the process of generating the matching image being completed, from displaying the waiting animation to displaying the matching image.

10. The method according to claim 1,
wherein the image generation trigger event includes a sharing operation for sharing the target document in a form of images, the matching image is displayed in the image generation window, and the image generation window includes a sharing operation option;
the method further comprising:
displaying a selection interface of a sharing object in response to a trigger operation for the sharing operation option, the selection interface including a plurality of user identifiers; and
sharing, in response to a selection operation for the plurality of user identifiers, the matching image with a user corresponding to one of the user identifiers selected by the selection operation.

11. The method according to claim 1, further comprising:
performing, in response to the image generation trigger event, semantic analysis on the target document to obtain the semantic information of the target document, and determining the image appearance attribute based on image attribute reference information and the semantic information;
determining the image content attribute based on the document content in the target document; and
performing typesetting on the image appearance attribute and the image content attribute to generate the matching image.

12. The method according to claim 11, wherein:
the semantic information of the target document includes an image theme corresponding to the target document; and
performing semantic analysis on the target document to obtain the semantic information of the target document includes:
acquiring text content from the document content of the target document, and performing pre-processing on the text content to obtain at least one sentence set, sentences in each of the at least one sentence set expressing semantics of a same category;
performing semantic analysis processing on the at least one sentence set to obtain a semantic analysis processing result, and predicting a first sub-image theme according to the semantic analysis processing result;
performing semantic inference processing on the at least one sentence set to obtain a semantic inference processing result, and predicting a second sub-image theme according to the semantic inference processing result; and
determining, based on the first sub-image theme and the second sub-image theme, the image theme corresponding to the target document.

13. The method according to claim 12, further comprising:
determining, in response to acquiring a specified theme corresponding to the target document, the specified theme as the image theme of the target document; and
performing, in response to not acquiring the specified theme corresponding to the target document, the operation of determining, based on the first sub-image theme and the second sub-image theme, the image theme corresponding to the target document.

14. The method according to claim 13, further comprising:
displaying an image theme adding window in response to the image generation trigger event, the image theme adding window being configured to set the specified theme.

15. The method according to claim 11, wherein:
the semantic information of the target document includes a target emotion reflected by the target document; and
performing semantic analysis on the target document includes:
acquiring text content from the document content of the target document, and performing pre-processing on the text content to obtain at least one sentence set, sentences in each of the at least one sentence set expressing semantics of a same category;
performing emotion analysis on the at least one sentence set to obtain an emotion analysis result; and
determining a target emotion reflected by the target document according to the emotion analysis result.

16. The method according to claim 11, wherein:
the image attribute reference information includes a plurality of first attributes and a plurality of hashtags each corresponding to one of the plurality of first attributes, each of the plurality of first attributes including at least one of a sticker element, a character style, or an image background;
the semantic information includes an image theme corresponding to the target document; and
determining the image appearance attribute based on the image attribute reference information and the semantic information includes:
performing similarity matching processing on the image theme and the plurality of hashtags in the image attribute reference information to determine a target hashtag; and
determining the first attribute corresponding to the target hashtag as the image appearance attribute.

17. The method according to claim 16, wherein:
the semantic information of the target document includes an image theme corresponding to the target document;
performing semantic analysis on the target document to obtain the semantic information of the target document includes:
acquiring text content from the document content of the target document, and performing pre-processing on the text content to obtain at least one sentence set, sentences in each of the at least one sentence set expressing semantics of a same category;
performing semantic analysis processing on the at least one sentence set to obtain a semantic analysis processing result, and predicting a first sub-image theme according to the semantic analysis processing result;
performing semantic inference processing on the at least one sentence set to obtain a semantic inference processing result, and predicting a second sub-image theme according to the semantic inference processing result; and
determining, based on the first sub-image theme and the second sub-image theme, the image theme corresponding to the target document, including taking both the first sub-image theme and the second sub-image theme as the image theme corresponding to the target document; and
performing similarity matching processing on the image theme and the plurality of hashtags in the image attribute reference information to determine the target hashtag includes:
determining a first hashtag that matches the first sub-image theme from the plurality of hashtags, and determining a matching degree corresponding to the first hashtag;
determining a second hashtag that matches the second sub-image theme from the plurality of hashtags, and determining a matching degree corresponding to the second hashtag; and
determining, based on the matching degree corresponding to the first hashtag and the matching degree corresponding to the second hashtag, the target hashtag from the first hashtag and the second hashtag.

18. The method according to claim 11, wherein:
the image appearance attribute includes image color theme, the image attribute reference information includes a correspondence between the image color theme and the emotion, and the semantic information of the target document includes the target emotion reflected by the target document; and
determining the image appearance attribute based on the image attribute reference information and the semantic information includes:
acquiring, based on the correspondence between the image color theme and the emotion, image color theme that matches the target emotion.

19. An image processing device comprising:
a processor; and
a computer-readable storage medium, storing one or more computer-readable instructions that, when executed by the processor, cause the processor to:
display a document editing interface, the document editing interface including a target document; and
display, in response to an image generation trigger event, a matching image that matches the target document, an image appearance attribute of the matching image characterizing semantic information of the target document, and an image content attribute of the matching image characterizing document content in the target document.

20. A non-transitory computer-readable storage medium, storing one or more computer-readable instructions that, when executed by a processor, cause the processor to:
display a document editing interface, the document editing interface including a target document; and
display, in response to an image generation trigger event, a matching image that matches the target document, an image appearance attribute of the matching image characterizing semantic information of the target document, and an image content attribute of the matching image characterizing document content in the target document.
